(19) United States
(12) Patent Application Publication
(10) Pub. No.: US 2004/0025040 A1
(43) Pub. Date: Feb. 5, 2004

(54) Memory device and encryption/decryption method

(75) Inventors: Tomokazu Aoki, Kanagawa (JP); Yoshihiro Emori, Kanagawa (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/375,123

(22) Filed: Feb. 28, 2003

(30) Foreign Application Priority Data
Aug. 2, 2002 (JP) 2002-226204

(51) Int. Cl. H04L 9/00

(52) U.S. Cl. 713/193

(57) ABSTRACT

A memory device which prevents lowering of processing efficiency of the entire system during processing for encryption or decryption of data. The first memory circuit stores data which is inputted through an external-bus-connection terminal. The second memory circuit is internally connected to the first memory circuit, acquires a duplicate of the data stored in the first memory circuit, and stores the duplicate of the data. The encryption/decryption circuit is internally connected to the second memory circuit, performs processing for encryption or decryption of the duplicate of the data stored in the second memory circuit, in response to an input of designation of an operation, and returns a result of the processing to the second memory circuit.

### CROSS-REFERENCE TO RELATED APPLICATIONS

This application is based upon and claims priority of Japanese Patent Application No. 2002-226204, filed on Aug. 2, 2002, the contents being incorporated herein by reference.

### BACKGROUND OF THE INVENTION

1) Field of the Invention

The present invention relates to a memory device and a method for encrypting or decrypting data stored in a memory device. In particular, the present invention relates to a memory device which is used for temporary storage of data to be encrypted or decrypted, and a method for encrypting or decrypting data stored in such a memory device.

2) Description of the Related Art

Recently, communication of information using a wide-area network such as the Internet has become very popular. When information is transmitted and received through the Internet, there is a danger that data on a transmission line is intercepted by a third party. Therefore, data is encrypted before transmission. In the case where data transmitted through a network is encrypted by using a strong encryption technique, it is difficult for a third party to decrypt the data even when the third party acquires the data without proper authorization. Thus, information leakage can be prevented.

FIG. 26 is a diagram illustrating an outline of a construction of a computer which has a function of secrecy protection. As illustrated in FIG. 26, the computer having the function of security protection comprises a CPU (central processing unit) 910, an encryption/decryption unit 920, a storage device 930, and the like. The CPU 910 controls the entire computer system, and exchanges data with the encryption/decryption unit 920 and the storage device 930. The encryption/decryption unit 920 performs processing for encryption or decryption of data which are inputted thereto. The encryption/decryption unit 920 can be realized by either hardware or software. The storage device 930 can be realized by, for example, a RAM (random access memory).

When encrypted communication is performed by using the above computer system, data (encrypted messages) 931, 932, . . . 933, and 934 which are encrypted and transmitted from outside are stored in the storage device 930. The data 931, 932, . . . 933, and 934 are divided into units of word (64 bits), and stored as N words, “DATA#1” to “DATA#N,” where N is a natural number.

The CPU 910 successively reads out the data 931, 932, . . . 933, and 934 from the storage device 930 word by word (in step S71), and passes the data 931, 932, . . . 933, and 934 to the encryption/decryption unit 920 (in step S72). The encryption/decryption unit 920 decrypts the encrypted data, and passes to the CPU 910 plain-text data generated by the decryption (in step S73). When the CPU 910 receives the plain-text data, the CPU 910 writes the data in their original positions in the storage device 930 (in step S74).

On the other hand, when plain-text data is encrypted and transmitted, the CPU 910 successively passes the data to the encryption/decryption unit 920 as in the case of the decryption, and the data is successively encrypted on a word-by-word basis.

Thus, in communication of information through a network, the secrecy of the data which are transmitted and received can be preserved.

The VPN (virtual private network) apparatus is an example of an apparatus which performs communication of information, and performs processing for encryption or decryption of packets which are transmitted and received through a wide-area network such as the Internet.

FIG. 27 is a diagram illustrating an exemplary construction of a conventional VPN apparatus. In the conventional VPN apparatus 940, a DES (data encryption standard) processing unit 947 is directly connected to a CPU 941 without use of a memory bus 948. In addition, a ROM (read-only memory) 942, a RAM (random access memory) 943, and a DMA (direct memory access) device 944 are connected to the CPU 941 through the memory bus 948, and network interface cards (NIC) 945 and 946 are connected to the DMA device 944.

As an example of processing, processing for encrypting a packet 951 which is inputted through the NIC 945 is explained.

[Encryption Step 1] The packet 951 inputted through the NIC 945 is DMA transferred by the DMA device 944, and stored in the RAM 943.

[Encryption Step 2] The CPU 941 analyzes an IP header of the packet 951 stored in the RAM 943, where the analysis includes check sum, filtering, acquisition of routing information by an IP address search, change of a protocol type, and the like.

[Encryption Step 3] The CPU 941 acquires data in words of 64 bits from a payload data portion of the packet 951 stored in the RAM 943, and passes the acquired data to the DES processing unit 947. Then, the DES processing unit 947 performs DES processing (encryption). Although, in the example of FIG. 27, the DES processing unit 947, which is arranged outside the CPU 941, performs the DES processing, it is possible to perform the DES processing by the CPU 941 (software). Data obtained by the DES processing (encryption) is returned to the RAM 943.

[Encryption Step 4] The CPU 941 produces data for authentication, based on the encrypted data after the DES processing.

[Encryption Step 5] The CPU 941 produces an IP header for tunneling.

[Encryption Step 6] At this time, an encrypted packet is produced, and the DMA device 944 transfers the packet to the NIC 946 by DMA. Then, the encrypted packet 952 is transmitted from the NIC 946.

Next, processing for decrypting an encrypted packet 952 which is inputted through the NIC 946 is explained.

[Decryption Step 1] The encrypted packet 952 inputted through the NIC 946 is DMA transferred by the DMA device 944, and stored in the RAM 943.

[Decryption Step 2] The CPU 941 analyzes an IP header of the encrypted packet 952 stored in the RAM 943, where the analysis includes check sum, filtering, acquisition of routing information by an IP address search, change of a protocol type, and the like.

[Decryption Step 3] The CPU 941 reads the encrypted data, produces data for authentication, based on the encrypted data, and performs authentication by comparison with authentication data contained in the encrypted packet 952.

[Decryption Step 4] The CPU 941 acquires data in words of 64 bits from a payload data portion of the packet 952 stored in the RAM 943, and passes the acquired data to the DES processing unit 947. Then, the DES processing unit 947 performs DES processing (decryption). Although, in the example of FIG. 27, the DES processing unit 947, which is arranged outside the CPU 941, performs the DES processing, it is possible to perform the DES processing by the CPU 941 (software). Data obtained by the DES processing (decryption) is returned to the RAM 943.

[Decryption Step 5] At this time, a decrypted packet 951 is produced, and the DMA device 944 transfers the packet to the NIC 945 by DMA. Then, the decrypted packet 951 is outputted from the NIC 945.

However, in order to perform encryption or decryption by the conventional technique, a CPU, an encryption/decryption unit (e.g., a DES processing unit), and a storage device (e.g., a RAM) are required. Therefore, in the case where a predetermined buffer area in the storage device is used for storing data to be processed, it is- necessary to perform read and write operations the number of which is proportional to the length of data to be processed, in order to convert a plain text to an encrypted text or an encrypted text to a plain text.

Since it takes several to several tens of cycles to perform the above read and write operations, the dead cycle (i.e., the time for which the CPU 910 waits for data) increases with the length of the data. In addition, the read and write operations are performed by the CPU or a DMA device. Therefore, the memory bus is occupied while data to be processed is transferred. Thus, it is substantially impossible to proceed with the system operation until the processing for the encryption or decryption is completed.

Hereinbelow, the highness of the bus occupation rate in the conventional technique is explained by the example of the sequence of processing in the VPN apparatus 940 illustrated in FIG. 27.

The bus occupation mainly occurs in the following steps, which are sequentially executed.

The sequence of encryption includes the steps of: 1. DMA transfer; 2. Reading of an IP header for IP header analysis by the CPU; 3. Reading and writing of data for DES processing (encryption) by the CPU; 4. Reading and writing of data for production of authentication data based on data obtained by the DES processing; and 5. DMA transfer.

The sequence of decryption includes the steps of: 1. DMA transfer; 2. Reading of a tunneling IP header for analysis of the tunneling IP header by the CPU; 3. Reading and writing for production of authentication data based on encrypted data and comparison; 4. Reading and writing of data for DES processing (decryption) by the CPU; and 5. DMA transfer.

In either of the sequences of encryption and decryption, the memory bus is occupied in every step. Therefore, the above steps are required to be sequentially executed. In particular, in each step of the DES processing, the number of the reading and writing operations performed in units of 64 bits is equal to the length of a packet divided by 64 (bits). Thus, the memory bus is occupied by the CPU during these reading and writing operations.

### SUMMARY OF THE INVENTION

The present invention is made in view of the above problems, and the object of the present invention is to provide a memory device and a method for encrypting or decrypting data, which can prevent lowering of processing efficiency of the entire system associated with processing for encryption or decryption of data.

In order to accomplish the above object, a memory device is provided. The memory device is characterized by comprising: a first memory circuit which stores data inputted through an external-bus-connection terminal; a second memory circuit which is internally connected to the first memory circuit, acquires a duplicate of the data stored in the first memory circuit, and stores the duplicate; and an encryption/decryption circuit which is internally connected to the second memory circuit, performs processing for encryption or decryption of the duplicate of the data stored in the second memory circuit, in response to an input of designation of an operation, and returns a result of the processing to the second memory circuit.

In addition, in order to accomplish the above object, a method for performing processing for encryption or decryption of data which is inputted or outputted in and from a memory device is provided. The method is characterized by comprising the steps of: (a) storing data which is inputted into the memory device through an external-bus-connection terminal, in a first memory circuit in the memory device; (b) performing processing for encryption or decryption of a duplicate of the data stored in the first memory circuit, in response to an input of designation of an operation, by using an encryption/decryption circuit which is internally connected to the first memory circuit in the memory device; and (c) storing a result of the processing in a second memory circuit which is internally connected to the encryption/decryption circuit.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in embodiments;

FIG. 2 is a diagram for explaining operations in the DES-CBC mode;

FIG. 3 is a diagram illustrating an exemplary construction of a VPN system;

FIG. 4 is a diagram illustrating an internal construction of a VPN apparatus;

FIG. 5 is a diagram illustrating an exemplary construction of a secret-data-protection memory module in a first embodiment;

FIG. 6 is a diagram illustrating a state machine of a counter circuit;

FIG. 7 is a diagram for explaining operations in the DES-ECB mode;

FIG. 8 is a diagram illustrating an exemplary construction of a secret-data-protection memory module in a second embodiment;

FIG. 9(A) is a diagram illustrating 3DES encryption processing;

FIG. 9(B) is a diagram illustrating 3DES decryption processing;

FIG. 10 is a diagram illustrating a construction of a circuit for realizing encryption/decryption processing in a third embodiment;

FIG. 11 is a diagram illustrating an exemplary construction of a secret-data-protection memory module in a fourth embodiment;

FIG. 12 is a diagram illustrating memory areas in the case where data to be encrypted or decrypted are limited;

FIG. 13 is a diagram illustrating an exemplary construction of a secret-data-protection memory module in a fifth embodiment;

FIG. 14 is a diagram illustrating a state machine of a counter circuit;

FIG. 15 is a diagram illustrating an exemplary construction of a secret-data-protection memory module in a sixth embodiment;

FIG. 16 is a diagram illustrating a state during reception of a raw packet;

FIG. 17 is a diagram illustrating a state after completion of encryption processing;

FIG. 18 is a diagram illustrating a state after generation of data in a tunnel mode;

FIG. 19 is a diagram illustrating a state during reception of an encrypted packet;

FIG. 20 is a diagram illustrating a state in authentication processing performed during decryption processing;

FIG. 21(A) is a diagram illustrating a sequence of encryption processing by a conventional technique for comparison with a technique according to the present invention;

FIG. 21(B) is a diagram illustrating a sequence of encryption processing by the technique according to the present invention for comparison with the conventional technique;

FIG. 22(A) is a diagram illustrating a sequence of decryption processing by a conventional technique for comparison with a technique according to the present invention;

FIG. 22(B) is a diagram illustrating a sequence of decryption processing by the technique according to the present invention for comparison with the conventional technique;

FIG. 23 is a diagram illustrating an exemplary construction of a ring buffer used in a seventh embodiment;

FIG. 24 is a diagram illustrating an example of an ID card used in an eighth embodiment;

FIG. 25 is a diagram illustrating an example of an ID card used in a ninth embodiment;

FIG. 26 is a diagram illustrating an outline of a construction of a computer which has a function of secrecy protection; and

FIG. 27 is a diagram illustrating an exemplary construction of a conventional VPN apparatus.

### DESCRIPTION OF THE PREFERRED EMBODIMENTS

Embodiments of the present invention are explained below with reference to drawings.

First, an outline of the present invention which is realized in the embodiments is explained, and thereafter details of the embodiments are explained.

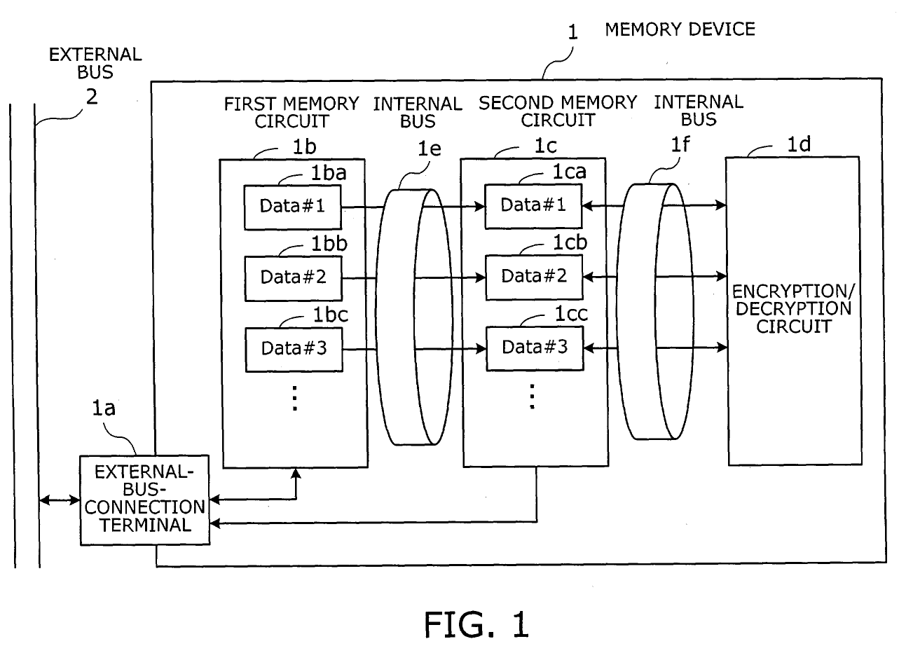

FIG. 1 is a conceptual diagram illustrating the present invention which is realized in embodiments. The memory device 1 illustrated in FIG. 1 comprises an external-bus-connection terminal 1a, a first memory circuit 1b, a second memory circuit 1c, an encryption/decryption circuit 1d, and internal buses 1e and 1f.

The external-bus-connection terminal 1a is a connection terminal for connecting the memory device 1 to an external bus 2. The external bus 2 is a memory bus which is connected to a CPU.

The first memory circuit 1b stores data 1ba, 1bb, 1bc, . . . inputted form the external-bus-connection terminal. The data 1ba, 1bb, 1bc, . . . are divided into units of a predetermined data length, and are then stored. For example, the unit data is a word having a length of 64 bits. It is possible to write or read data in the first memory circuit 1b by memory access through the external bus 2.

The second memory circuit 1c is internally connected to the first memory circuit 1b. For example, the first memory circuit 1b and the second memory circuit 1c are connected through the internal bus 1e. The second memory circuit 1c acquires duplicate data 1ca, 1cb, 1cc, . . . of the data 1ba, 1bb, 1bc, . . . which are stored in the first memory circuit 1b, and stores the duplicate data 1ca, 1cb, 1cc, . . . . It is also possible to read data in the second memory circuit 1c by memory access through the external bus 2.

The encryption/decryption circuit 1d is internally connected to the second memory circuit 1c. For example, the second memory circuit 1c and the encryption/decryption circuit 1d are connected through the internal bus 1f. The encryption/decryption circuit 1d performs processing for encryption or decryption of the duplicate data 1ca, 1cb, 1cc, . . . which are stored in the second memory circuit 1c, in response to an operational instruction which is inputted from outside, and returns a result of the processing to the second memory circuit 1c. The operational instruction indicates whether to perform processing for encryption or decryption.

When the data 1ba, 1bb, 1bc, . . . are inputted into the memory device 1 from the external-bus-connection terminal 1a, the data 1ba, 1bb, 1bc, . . . are first stored in the first memory circuit 1b, and the duplicate data 1ca, 1cb, 1cc, . . . of the data 1ba, 1bb, 1bc, . . . are stored in the second memory circuit 1c. Then, the encryption/decryption circuit 1d performs processing for encryption or decryption of the duplicate data 1ca, 1cb, 1cc, . . . , and returns a result of the processing to the second memory circuit 1c.

Thus, when data to be encrypted or decrypted is inputted into the memory device 1, encrypted or decrypted data is generated in the second memory circuit 1c. Since the processing for encryption or decryption is performed within the memory device 1, the external bus 2 is not occupied during the processing. In addition, since the processing for encryption or decryption is performed on the duplicate data 1ca, 1cb, 1cc, . . . , the first memory circuit 1b can be used in a similar manner to the general main memory devices (e.g., the data 1ba, 1bb, 1bc, . . . in the first memory circuit 1b can be written or read out) even during the processing for encryption or decryption.

Consequently, the efficiency in the processing for encryption or decryption can be increased, and the processing speed can be increased.

Hereinbelow, embodiments of the present invention are explained in detail, where DES (data encryption standard) is used as an encryption/decryption technique.

The operational modes of the DES include the CBC (cipher block chaining) mode, the EBC (electronic code book) mode, and the 3DES (triple DES), which includes the triple-EBC and the triple-CBC. In the following explanations, apparatuses realizing the embodiments in the respective modes are explained. Thereafter, an apparatus which allows selection of an arbitrary encryption/decryption technique and other applications are explained.

[First Embodiment]

In the first embodiment, the present invention is applied to a system which performs encryption or decryption in the DES-CBC mode. In the DES-CBC mode, an exclusive logical sum (XOR) of an encrypted text output of the first word (64 bits) and an input of the next word is calculated, and the calculated result becomes an input to DES calculation in the next stage.

Incidentally, when the memory device 1 illustrated in FIG. 1 is mounted on a memory module, it is easy to connect the memory device 1 to a memory bus to which a memory module of an existing RAM is connected. Therefore, in the first embodiment, a function of protection of secret data is implemented on a memory module.

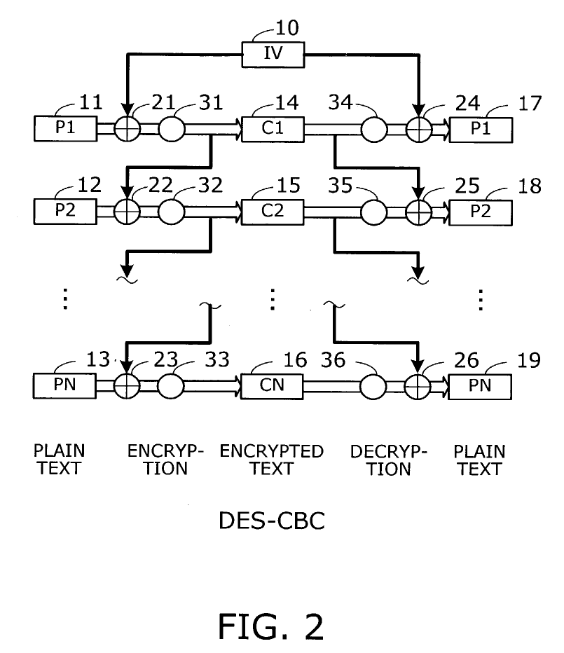

FIG. 2 is a diagram for explaining operations in the DES-CBC mode. In FIG. 2, a plain text data item is divided into N words 11, 12, and 13, where N is a natural number. In addition, the contents of the first word 11 is denoted by “P1,” the contents of the second word 12 is denoted by “P2,” and the contents of the last word 13 is denoted by “PN.” Further, an IV (initial vector) 10 is prepared in advance.

In the case where a plain text is encrypted, an exclusive-logical-sum calculation unit 21 calculates an exclusive logical sum of the first word 11 having the contents “P1” and the IV 10, and an encryption unit 31 encrypts data of the calculation result, so that an encrypted word 14 having the content “C1” is generated.

An exclusive-logical-sum calculation unit 22 calculates an exclusive logical sum of the second word 12 having the contents “P2” and the word 14 which is encrypted in the processing in the preceding stage, and an encryption unit 32 encrypts data of the calculation result, so that an encrypted word 15 having the content “C2” is generated.

Similarly, encryption of the respective words is performed. Finally, an exclusive-logical-sum calculation unit 23 calculates an exclusive logical sum of the Nth word 13 having the contents “PN” and a word which is encrypted in processing in the (N-1)th stage, and an encryption unit 33 encrypts data of the calculation result, so that an encrypted word 16 having the content “CN” is generated.

The encrypted data 14, 15, and 16 constitute an encrypted text.

In the case where the encrypted text is converted (decrypted) to a plain text, a decryption unit 34 decrypts the first data 14 having the contents “C1,” and an exclusive-logical-sum calculation unit 24 calculates an exclusive logical sum of the decrypted data and the VI 10, so that a decrypted word 17 having the content “P1” is generated.

In addition, a decryption unit 35 decrypts the second data 15 having the contents “C2,” and an exclusive-logical-sum calculation unit 25 calculates an exclusive logical sum of the decrypted data and the data 14 having the contents “C1,” so that a decrypted word 18 having the content “P2” is generated.

Similarly, decryption of the respective words is performed. Finally, a decryption unit 36 decrypts the Nth word 16 having the contents “CN,” and an exclusive-logical-sum calculation unit 26 calculates an exclusive logical sum of the decrypted data and a plain word which is obtained in the preceding stage, so that a word 19 having the content “PN” is generated.

The contents of a plain text which is constituted by the words 17, 18, and 19 generated as above are identical to the contents of the plain text constituted by the words 11, 12, and 13.

Since the encryption/decryption processing is performed by using a preceding block in a chain-like manner as described above, unauthorized decryption is difficult.

Therefore, when data is encrypted in the DES-CBC mode, it is possible to preserve secrecy of the data even when the data is transmitted through the Internet. In addition, it is possible to construct, for example, a VPN by using the above technique. The VPN is a private network environment constructed by using a public network which can be used by anybody such as the Internet. In the private network environment, secrecy of data is preserved.

When a VPN is constructed, VPN apparatuses are arranged between a wide-area network and private networks, and relay packets. The throughput of the VPN apparatuses (i.e., the data transfer rates between the Internet and intranets) can be increased by providing a memory module having a function for preserving secrecy in the VPN apparatuses. Hereinafter, a memory module in which an encryption/decryption function for preserving secrecy is installed is referred to as a secret-data-protection memory module.

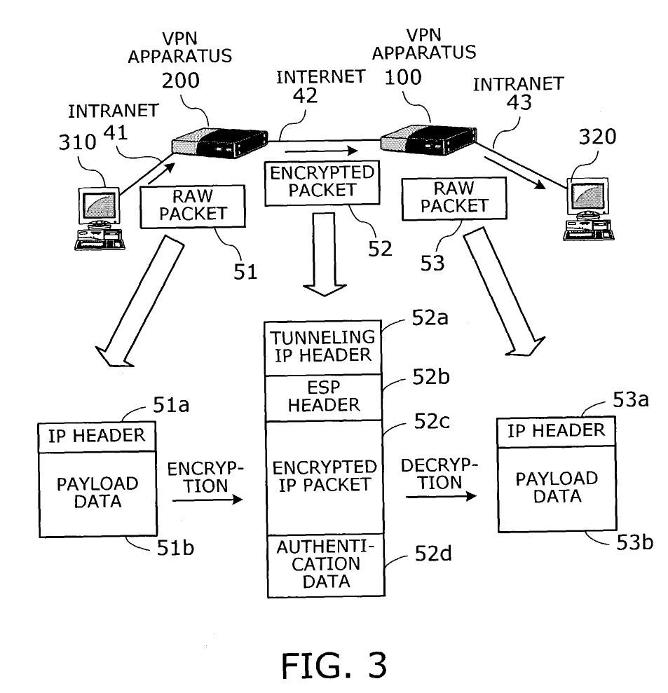

FIG. 3 is a diagram illustrating an exemplary construction of a VPN system. In the VPN of FIG. 3, two VPN apparatuses 100 and 200 are connected through the Internet 42. The VPN apparatus 200 is connected to an intranet 41, to which a computer 310 is connected. The VPN apparatus 100 is connected to an intranet 43, to which a computer 320 is connected.

As an example, a case where data is transmitted from the computer 310 to the computer 320 is explained.

First, a raw IP (Internet Protocol) packet 51 is outputted from the computer 310. Hereinafter, a raw IP packet is also referred to as a raw packet. The raw packet 51 is constituted by an IP header 51a, payload data 51b (transmitted data per se), and the like. The raw packet 51 is transmitted to the VPN apparatus 200 through the intranet 41.

The VPN apparatus 200 generates an encrypted packet 52 by encrypting the raw packet 51. The encrypted packet 52 is constituted by a tunneling IP header 52a, an ESP (encapsulating security payload) header 52b, an encrypted IP packet 52c, authentication data 52d, and the like. The tunneling IP header 52a is header information for transmitting the encrypted packet 52 to the VPN apparatus 100 through the Internet 42. The ESP header 52b is information on an encryption algorithm, key information, and the like. The encrypted IP packet 52c is encrypted data which is obtained by encrypting the raw packet 51 for each IP header 51a. The authentication data 52d is data for authentication such as checksum of the IP header 51a. The encrypted packet 52 is transferred to the VPN apparatus 100 through the Internet 42.

The VPN apparatus 100 decrypts the encrypted IP packet 52c by using the ESP header 52b. In addition, by using the authentication data 52d, the VPN apparatus 100 authenticates the encrypted IP packet 52c as a proper packet which is not falsified. Thereafter, the VPN apparatus 100 outputs the raw packet 53 obtained by the decryption of the encrypted IP packet 52c. The raw packet 53 contains an IP header 53a and payload data 53b. The raw packet 53 is transferred to the computer 320 through the intranet 43.

Thus, the secrecy of data is preserved during the transmission of the data through the Internet 42.

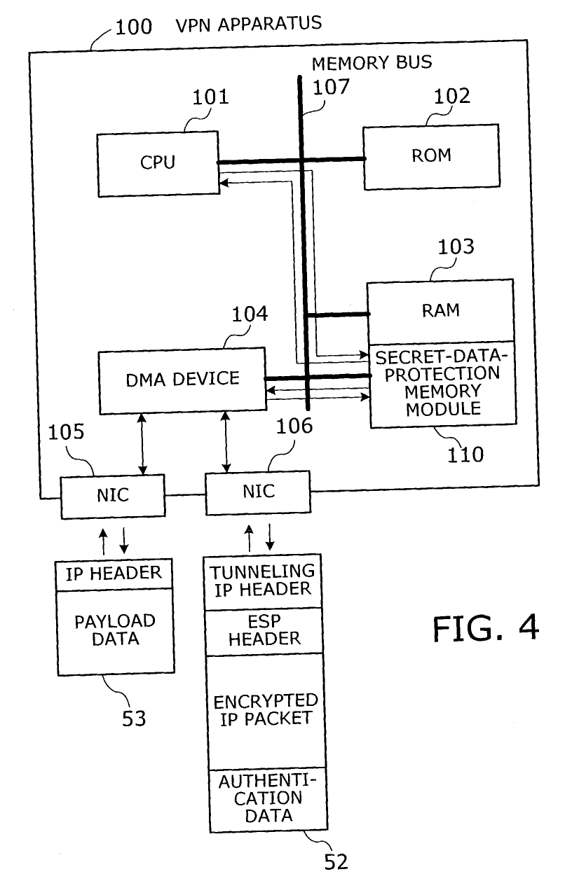

FIG. 4 is a diagram illustrating an internal construction of the VPN apparatus 100. The entire VPN apparatus 100 is controlled by a CPU 101, to which a ROM 102, a RAM 103, a DMA device 104, and a secret-data-protection memory module 110 are connected through a memory bus 107.

The ROM 102 stores a program which describes basic operations of the VPN apparatus 100. The CPU 101 reads the program stored in the ROM 102, and controls the VPN apparatus 100. The RAM 103 temporarily stores data and instructions which are necessary for processing executed by the CPU 101.

The DMA device 104 can access the RAM 103 and the secret-data-protection memory module 110 in a DMA (direct memory access) mode. Two network interface cards (NICs) 105 and 106 are connected to the DMA device 104. The NIC 105 is a network control circuit connected to the intranet 43, and the NIC 106 is a network control circuit connected to the Internet 42.

The DMA device 104 performs DMA transfer of packets which are inputted and outputted through the NICs 105 and 106. For example, when a raw packet 53 which is to be transmitted through the Internet 42 is inputted into the NIC 105, the DMA device 104 transfers the raw packet 53 to the secret-data-protection memory module 110 by DMA. When the raw packet 53 is encrypted, the DMA device 104 acquires the encrypted packet 52 from the secret-data-protection memory module 110, and transfers the encrypted packet 52 to the NIC 106 by DMA.

In addition, when an encrypted packet 52 which is to be transmitted through the Internet 43 is inputted into the NIC 106, the DMA device 104 transfers the encrypted packet 52 to the secret-data-protection memory module 110 by DMA. When the encrypted packet 52 is decrypted, the DMA device 104 acquires the decrypted packet (a raw packet 53) from the secret-data-protection memory module 110, and transfers the decrypted packet to the NIC 105 by DMA.

The secret-data-protection memory module 110 is a memory module which can store a packet inputted thereto, and perform processing for encryption or decryption of the packet. For example, the secret-data-protection memory module 110 performs processing for encryption or decryption of data by using the DES technique. In the first embodiment, the secret-data-protection memory module 110 has a function of secrecy protection in the DES-CBC mode.

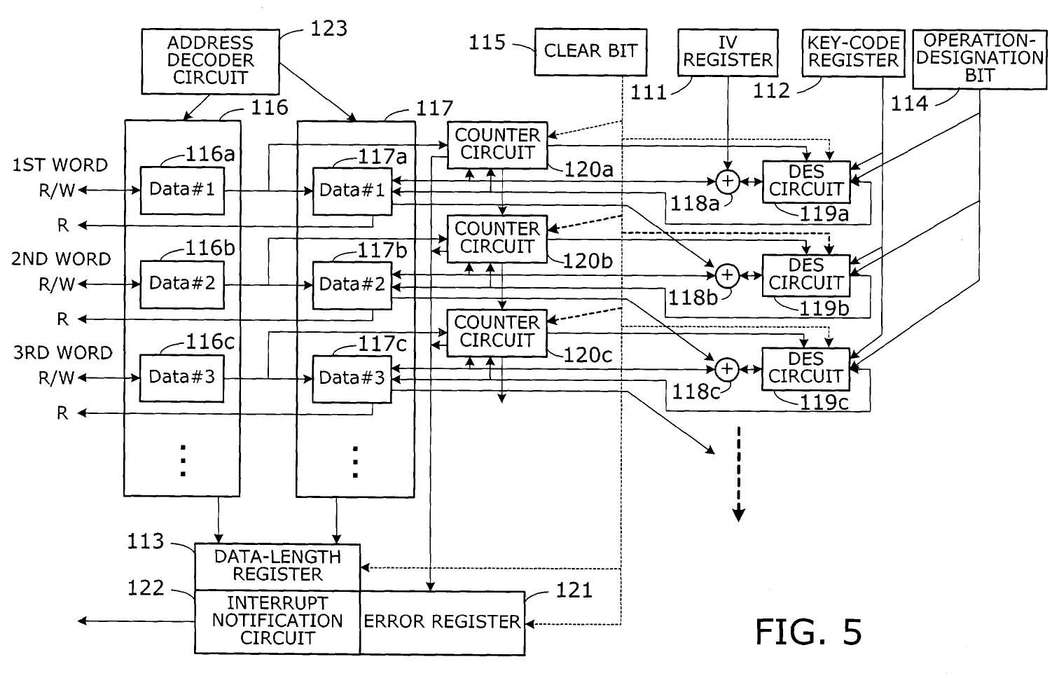

FIG. 5 is a diagram illustrating an exemplary construction of the secret-data-protection memory module in the first embodiment. The memory module having the function of secrecy protection in the DES-CBC mode comprises an IV register 111, a key-code register 112, a data-length register 113, an operation-designation bit 114, a clear bit 115, a first-stage memory 116, a second-stage memory 117, exclusive-logical-sum circuits 118a, 118b, 118c, . . . , DES circuits 119a, 119b, 119c, . . . , counter circuits 120a, 120b, 120c, . . . , an error register 121, an interrupt notification circuit 122, and an address decoder circuit 123.

The IV register 111 is connected to the exclusive-logical-sum circuit 118a. The key-code register 112 is connected to the DES circuits 119a, 119b, 119c, . . . . The data-length register 113 is connected to the first-stage memory 116 and the second-stage memory 117. The operation-designation bit 114 is connected to the DES circuits 119a, 119b, 119c, . . . . The clear bit 115 is connected to the DES circuits 119a, 119b, 119c, . . . , the counter circuits 120a, 120b, 120c, . . . , the error register 121, and the data-length register 113.

The first-stage memory 116 is partitioned into a plurality of buffer areas 116a, 116b, 116c, . . . , where the CPU 101 can write and read data in and from the plurality of buffer areas 116a, 116b, 116c . . .

The second-stage memory 117 is partitioned into a plurality of buffer areas 117a, 117b, 117c, . . . from which the CPU 101 can read data. The buffer areas in the first-stage memory 116 correspond one-to-one with the buffer areas in the second-stage memory 117, and the corresponding buffer areas are connected. The counter circuit 120a is connected to a signal line which connects the buffer areas 116aand 117a. The counter circuit 120b is connected to a signal line which connects the buffer areas 116band 117b. The counter circuit 120c is connected to a signal line which connects the buffer areas 116c and 117c.

The buffer area 117a in the second-stage memory 117 is connected to the exclusive-logical-sum circuit 118a, the DES circuit 119a, and the exclusive-logical-sum circuit 118b. The counter circuit 120a is also connected to a signal line for sending data from the DES circuit 119a to the buffer area 117a and a signal line for sending data from the exclusive-logical-sum circuit 118a to the buffer area 117a.

The buffer area 117b in the second-stage memory 117 is connected to the exclusive-logical-sum circuit 118b, the DES circuit 119b, and the exclusive-logical-sum circuit 118c. The counter circuit 120b is also connected to a signal line for sending data from the DES circuit 119b to the buffer area 117b and a signal line for sending data from the exclusive-logical-sum circuit 118b to the buffer area 117b.

The buffer area 117c in the second-stage memory 117 is connected to the exclusive-logical-sum circuit 118c, the DES circuit 119c, and an exclusive-logical-sum circuit in the following stage (not shown). The counter circuit 120c is also connected to a signal line for sending data from the DES circuit 119c to the buffer area 117c and a signal line for sending data from the exclusive-logical-sum circuit 118c to the buffer area 117c.

The counter circuit 120a is further connected to the counter circuit 120b, the DES circuit 119a, and the error register 121. The counter circuit 120b is further connected to the counter circuit 120c, the DES circuit 119b, and the error register 121. The counter circuit 120c is further connected to a counter circuit (not shown), the DES circuit 119c, and the error register 121.

The interrupt notification circuit 122 is connected to the data-length register 113, the error register 121, and an output line of an interrupt notification signal to the CPU 101. The address decoder circuit 123 is connected to the first-stage memory 116 and the second-stage memory 117.

The IV register 111 is a 64-bit register for setting the IV (initial vector), which is data to be input to the exclusive-logical-sum circuit 118a for calculating an exclusive logical sum between the IV and the first word of data. Although the CPU 101 can access the IV register 111 for writing data in the IV register 111, the CPU 101 cannot read data from the IV register 111.

The key-code register 112 is a 64-bit register for setting a key code. Specifically, 56 bits in the key-code register 112 represent the key code, and the remaining eight bits are parity bits. Although the CPU 101 can access the key-code register 112 for writing a key code in the key-code register 112, the CPU 101 cannot read the key code from the key-code register 112.

The data-length register 113 is a 64-bit register for indicating the length (the number of words) of DES processed data. Specifically, 32 more significant bits in the data-length register 113 represent the number of words stored in the first-stage memory 116, and 32 less significant bits in the data-length register 113 represent the number of DES processed words stored in the second-stage memory 117. Although the CPU 101 cannot write data in the data-length register 113, the CPU 101 can access the data-length register 113 for reading data from the data-length register 113.

The operation-designation bit 114 is provided for setting one-bit data (i.e., a flag) which indicates whether processing to be performed on data inputted into the VPN apparatus is decoding (decryption) or encoding (encryption). The CPU 101 can access the operation-designation bit 114, and write and read one-bit data in and from the operation-designation bit 114.

The clear bit 115 is one-bit data (i.e., a flag) for initializing circuits. The CPU 101 can access the clear bit 115, and write and read one-bit data in and from the clear bit 115.

The first-stage memory 116 is a RAM circuit having a 64-bit width and storing data to be DES processed. The CPU 101 can access the first-stage memory 116, and write and read data in and from the first-stage memory 116. That is, it is also possible to use the first-stage memory 116 as a main memory in a similar manner to the conventional RAM.

The second-stage memory 117 is a RAM circuit having a 64-bit width, storing duplicates of the data stored in the first-stage memory 116, and holding encrypted or decrypted data after DES processing. Although the CPU 101 cannot write data in the second-stage memory 117, the CPU 101 can access the second-stage memory 117 and read data from the second-stage memory 117.

The exclusive-logical-sum circuits 118a, 118b, 118c, . . . are circuits for making logical calculation so as to obtain exclusive logical sums on a word-by-word basis.

The DES circuits 119a, 119b, 119c, . . . are circuits for performing DES processing for encryption or decryption.

The counter circuits 120a, 120b, 120c, . . . are circuits for counting the number of words in data when each word is replaced, and controlling a start of execution of the DES processing. In other words, the counter circuits 120a, 120b, 120c, . . . perform processing for linking two words which are successively processed, and detect the order of processing of the respective words.

The processing for linking words which are successively processed is performed as follows.

That is, the respective counter circuits 120a, 120b, 120c, . . . are associated with words to be DES processed. A predetermined value is set in each of the counter circuits 120a, 120b, 120c, . . . when DES processing of a word associated with the counter circuit is completed.

The counter circuits 120a, 120b, 120c, . . . each monitor a value in a counter circuit in a preceding stage, and determine whether or not a preceding word in the order of processing is currently being encrypted or decrypted, based on whether or not the value in the counter circuit in the preceding stage is a predetermined value. In addition, when each counter circuit confirms completion of encryption or decryption of the preceding word in the order of processing, the counter circuit instructs a DES circuit to start DES processing of a word corresponding to the counter circuit.

The error register 121 is a register for indicating an error when unauthorized access occurs.

The interrupt notification circuit 122 is a circuit which sends an interrupt notification to the CPU 101 when the error register 121 indicates an error, or when the value represented by the 32 less significant bits in the data-length register 113 becomes equal to the value represented by the 32 more significant bits which is not zero.

The address decoder circuit 123 is connected to the first-stage memory 116 and the second-stage memory 117. In addition, the address decoder circuit 123 is connected to the CPU 101 through an external bus.

The address decoder circuit 123 is a decode circuit provided for selection of a word and selection of the first-stage memory 116 or the second-stage memory 117. For example, the interrupt notification circuit 122 checks the least significant bit of an address signal, and selects the first-stage memory 116 when the least significant bit is zero, and the second-stage memory 117 when the least significant bit is one.

Although the DES circuits 119a, 119b, 119c, . . . are provided in the example of FIG. 5, only one DES circuit suffices for realizing the present invention since the DES encryption/decryption processing is sequentially performed on a word-by-word basis. When only one DES circuit is shared by every word, the circuit size can be reduced.

Hereinbelow, manipulation of the secret-data-protection memory module 110 by the CPU 101 and various functions and operations of the secret-data-protection memory module 110 are explained along a sequence of actual data processing.

[Step S1] Initialization by the Clear Bit 115

The CPU 101 first sets “1” as the clear bit 115 before storage of a packet in the secret-data-protection memory module 110. When “1” is set to the clear bit 115, the circuits are initialized. Specifically, “01” is set in each of the error register 121 for error indication and the data-length register 113 for indicating a data length. In addition, “0” is also set to the counter circuits 120a, 120b, 120c, . . . . Further, the values set in the DES circuits 119a, 119b, 119c, . . . by previous encryption/decryption processing are cleared (e.g., “0” is set to the DES circuits 119a, 119b, 119c, . . . ).

After the circuits are initialized, the clear bit 115 changes from “1” to “0,” which indicates completion of the initialization.

[Step S2] Setting of IV and Key Code

The CPU 101 sets an IV (initial vector) and a key code used in DES processing in the IV register 111 and the key-code register 112, respectively. The IV set in the IV register 111 is inputted into the exclusive-logical-sum circuit 118a which is used in processing of the first word. The key code set in the key-code register 112 is inputted into the DES circuits 119a, 119b, 119c, . . .

[Step S3] Operational Setting to Encryption or Decryption (Conversion to Plain Text)

The CPU 101 sets a mode indicating encryption or decryption in the operation-designation bit 114. In this embodiment, the operation-designation bit 114 is set to “1” in the case of decryption, and “0” in the case of encryption. The value set in the operation-designation bit 114 is inputted into the DES circuits 119a, 119b, 119c, . . .

[Step S4] DES Processing

The CPU 101 writes a packet to be processed, in the first-stage memory 116. In the case of a packet transmitted from the intranet 43 to the Internet 42, the packet written in the first-stage memory 116 is a raw packet. On the other hand, in the case of a packet transmitted from the Internet 42 to the intranet 43, the packet written in the first-stage memory 116 is an encrypted packet.

The packet is written in the buffer areas 116a, 116b, 116c, . . . in the first-stage memory 116 in units of 64 bits. The data length (the number of words) of the stored packet is set in the 32 more significant bits of the data-length register 113. Thus, it is possible to recognize the data length of the packet to be processed, by referring to the 32 more significant bits of the data-length register 113.

The packet stored in the first-stage memory 116 is immediately copied into the second-stage memory 117. Then, the counter circuits 120a, 120b, 120c, . . . cooperate to control the processing timings of words stored in the buffer areas 117a, 117b, 117c, . . . in the second-stage memory 117. Thus, the words stored in the buffer areas 117a, 117b, 117c, . . . are sequentially processed with DES from the first word stored in the buffer area 117a. The cooperation processing of the counter circuits 120a, 120b, 120c, . . . is explained later.

When the processing is started, first, it is determined whether or not the operation-designation bit 114 indicates encryption or decryption. Specifically, the value “1” of the operation-designation bit 114 indicates decryption, and the value “0” of the operation-designation bit 114 indicates encryption.

In the case of encryption, the first data stored in the buffer area 117a is inputted into the exclusive-logical-sum circuit 118a. Then, the exclusive-logical-sum circuit 118a calculates an exclusive logical sum of the inputted word and the IV, and the calculation result is inputted into the DES circuit 119a. The DES circuit 119a performs DES processing according to the value of the operation-designation bit 114. Specifically, the DES circuit 119a encrypts the inputted data by using the key code stored in the key-code register 112. The DES processed data is stored in the buffer area 117a in which the original word is stored.

In the case of decryption, the first data stored in the buffer area 117a is inputted into the DES circuit 119a. Then, the DES circuit 119a performs DES processing according to the value of the operation-designation bit 114. Specifically, the DES circuit 119a decrypts the inputted data by using the key code stored in the key-code register 112. The DES processed data is inputted into the exclusive-logical-sum circuit 118a. Then, the exclusive-logical-sum circuit 118a calculates an exclusive logical sum of the word inputted into the exclusive-logical-sum circuit 118a and the IV. The calculation result is stored in the buffer area 117a in which the original word is stored.

Next, processing for encrypting or decrypting the next word stored in the buffer area 117b is performed.

In the case of encryption, the next data stored in the buffer area 117b is inputted into the exclusive-logical-sum circuit 118b. Then, the exclusive-logical-sum circuit 118b calculates an exclusive logical sum of the inputted word and the data stored in the buffer area 117a (i.e., the result of the DES processing in the preceding stage), and the calculation result is inputted into the DES circuit 119b. Specifically, the DES circuit 119b performs DES processing (encryption) according to the value of the operation-designation bit 114. The DES processed data is stored in the buffer area 117b in which the original word is stored.

In the case of decryption, the next data stored in the buffer area 117b is inputted into the DES circuit 119b. Then, the DES circuit 119b performs DES processing (decryption) according to the value of the operation-designation bit 114. The DES processed data is inputted into the exclusive-logical-sum circuit 118b. Then, the exclusive-logical-sum circuit 118b calculates an exclusive logical sum of the word inputted into the exclusive-logical-sum circuit 118b and the data stored in the buffer area 117a (i.e., the result of the DES processing in the preceding stage). The calculation result is stored in the buffer area 117b in which the original word is stored.

Subsequently, DES processing of the data stored in the second-stage memory 117 is performed on a word-by-word basis. Every time DES processing of a word is performed, the processed data is stored in a buffer area in the second-stage memory 117 in which the original word is stored.

The packet stored in the first-stage memory 116 can be read by the CPU 101 even during the DES processing of the data stored in the second-stage memory 117.

[Step S5] Setting of Length of Processed Data

The length (the number of words) of the data which has been DES processed and stored in the second-stage memory 117 is set in the 32 less significant bits in the data-length register 113. Thus, the CPU 101 can recognize the length of a portion of data which has been DES processed, by referring to the 32 less significant bits of the data-length register 113.

[Step S6] Reading of Encrypted or Decrypted Data by Second-Stage Memory 117

The CPU 101 accesses the second-stage memory 117, and reads data which has been encrypted or decrypted by DES, when necessary. Since the length (the number of words) of the data which has been DES processed is indicated by the 32 less significant bits of the data-length register 113, the CPU 101 can read only the portion of data which has been DES processed, by referring to the 32 less significant bits of the data-length register 113.

When the value represented by the 32 less significant bits reaches the value represented by the 32 more significant bits, the interrupt notification circuit 122 sends an interrupt notification to the CPU 101. The CPU 101 can recognize completion of the entire processing based on the interrupt notification signal. When the CPU 101 reads the data-length register 113, the interrupt notification signal is deasserted (negated).

[Step S7] Error Notification on Occurrence of Error

When an unauthorized operation occurs, information indicating an error is set in the error register 121. When the information indicating an error is set in the error register 121, the interrupt notification circuit 122 sends an interrupt notification signal to the CPU 101. Thus, the CPU 101 recognizes the occurrence of the error, and reads in the contents of the error register 121. When the CPU 101 reads in the contents of the error register 121, the interrupt notification signal is deasserted.

As explained above, the processing for encryption or decryption is performed in the secret-data-protection memory module 110.

Hereinbelow, the roles of the counter circuits 120a, 120b, 120c, . . . are explained.

The counter circuits 120a, 120b, 120c, . . . are provided associated with the buffer areas each corresponding to a word. When a word stored in the first-stage memory 116 is copied into the second-stage memory 117, a corresponding counter circuit is incremented from “0” to “1.” When the DES processed data is returned to and written in the second-stage memory 117, a counter circuit corresponding to a buffer area in which the DES processed data written is incremented from “1” to “2.”

Every pair of successive ones of the counter circuits 120a, 120b, 120c, . . . are linked with each other. That is, when “1” is set in the counter circuit 120a corresponding to the first word, the counter circuit 120a outputs a signal which indicates an instruction to start DES processing. In addition, when each of the counter circuits 120b and 120c corresponding to the second and following words confirms that the value of a counter circuit in a preceding stage (located immediately above each of the counter circuits 120b and 120c in FIG. 5) becomes “2,” each of the counter circuits 120b and 120c outputs a signal which indicates an instruction to start DES processing. Thus, each of the counter circuits 120b and 120c refers to the value of the counter circuit in the preceding stage, and determines whether or not the DES processing of the preceding word is completed, i.e., whether or not DES processing of the next word can be started.

Specifically, when the value of the counter circuit 120a is incremented from “0” to “1,” the counter circuit 120a outputs an instruction to start DES processing. When the value of the counter circuit 120b is incremented from “0” to “1,” the counter circuit 120b refers to the count corresponding to the first word. When the count corresponding to the first word is “2,” the counter circuit 120b makes DES processing start. When the count corresponding to the first word is “1,” the counter circuit 120b waits for increment in the count corresponding to the first word to “2.” When the values of the counter circuits 120a, 120b, 120c, . . . are different from the above-mentioned values, the corresponding counter circuits determine that a wrong operation occurs, and output error information to the error register 121. According to this mechanism, it is possible to prevent an unauthorized, discontinuous write operation.

When the respective counter circuits 120a, 120b, 120c, . . . operate as above, it is possible to recognize the length of a portion of data which has been processed by DES, by referring to the values of the counter circuits 120a, 120b, 120c, . . . . That is, the number of counter circuits each of which indicates the value “2” indicates the length (the number of words) of the portion of data which has been processed by DES. Therefore, the number of counter circuits each of which indicates the value “2” is set in the 32 less significant bits in the data-length register 113.

Next, details of the processing performed by the counter circuits 120a, 120b, 120c, . . . are explained below.

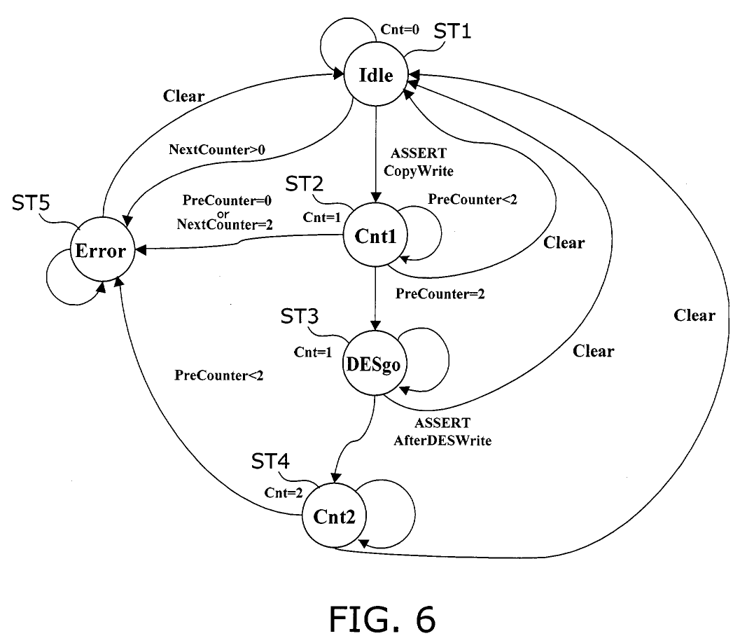

FIG. 6 is a diagram illustrating a state machine of each counter circuit. As indicated in FIG. 6, each of the counter circuits 120a, 120b, 120c, . . . can have five states. The first (Idle) state ST1 is an idle state, and the value of the counter is “0” in this state. The second (Cnt1) state ST2 is a state in which copying of a word is completed, and the value of the counter is “1” in this state. The third (DESgo) state ST3 is a state in which a DES-processing start signal is outputted, and the value of the counter is “1” in this state. The fourth (Cnt2) state ST4 is a state in which DES processing is completed, and the value of the counter is “2” in this state. The fifth (Error) state ST5 is a state in which an error occurs, and the value of the counter in this state can be any value.

The signals inputted into the counter circuits 120a, 120b, 120c, . . . are as follows.

CopyWrite: A write signal for copying data from the first-stage memory 116 into the second-stage memory 117

AfterDESWrite: A write signal for writing DES processed data in the second-stage memory 117

NextCounter[1:0] : A count value of a counter circuit in the next stage

PreCounter[1:0]: A count value of a counter circuit in the preceding stage (This value is fixed to “2” in the counter circuit in the first stage.)

Clear: A clear signal

SystemClock: A clock signal

In addition, the signals outputted from the counter circuits 120a, 120b, 120c, . . . are as follows.

ErrorSignal: An error signal

DESgo: A signal for starting execution of DES processing

Cnt[1:0]: A counter value

The states of the counter circuits 120a, 120b, 120c, . . . transition according to the above input and output signals.

First, in the first state ST1, “0” is set as the counter value. The first state ST1 is maintained while the count value is “0.” However, when the CopyWrite signal is asserted in the first state ST1, the counter circuit transitions to the second state ST2. When the signal (NextCounter[1:0]) indicating the count value of a counter circuit in the next stage becomes greater than 0 in the first state ST1, the counter circuit transitions to the fifth state ST5.

In the second state ST2, “1” is set as the counter value. When the count value (PreCounter) of a counter circuit in the preceding stage is less than two, the second state ST2 is maintained. When the count value (PreCounter) of the counter circuit in the preceding stage becomes two in the second state ST2, the counter circuit transitions to the third state ST3. When the clear signal (Clear) is outputted in the second state ST2, the counter circuit transitions to the first state ST1. When the count value (PreCounter) of the counter circuit in the preceding stage becomes “0,” or when the count value (NextCounter) of the counter circuit in the next stage becomes “2,” the counter circuit transitions to the fifth state ST5.

In the third state ST3, processing for outputting the signal (DESgo) for starting execution of DES processing is performed. In response to the output of this signal (DESgo), the DES processing is executed by a DES circuit corresponding to the counter circuit (i.e., in the same stage as the counter circuit). When the DES processing is executed, and the write (AfterDESWrite) signal for writing DES processed data in the second-stage memory 117 is asserted, the counter circuit transitions to the fourth state ST4. When the clear (Clear) signal is outputted in the third state ST3, the counter circuit transitions to the first state ST1.

In the fourth state ST4, “2” is set as the counter value. When the clear (Clear) signal is outputted in the fourth state ST4, the counter circuit transitions to the first state ST1. When the counter value (PreCounter) of the counter circuit in the preceding stage becomes less than two, the counter circuit transitions to the fifth state ST5.

In the fifth state ST5, error processing is executed. When the clear (Clear) signal is outputted in the fifth state ST5, the counter circuit transitions to the first state ST1.

According to the above mechanism, it is possible to efficiently perform encryption/decryption processing. For example, since a packet to be processed is immediately copied from the first-stage memory 116 into the second-stage memory 117, and DES processing is executed on the second-stage memory 117, data can be inputted into and outputted from the first-stage memory 116 even during DES processing. In addition, since the length of a portion of data which has been DES processed can be recognized by referring to the data-length register 113, it is possible to use respective portions of the DES processed data in the order in which the respective portions are DES processed, for example, for analysis processing by the CPU 101. Further, every time a word is written in a buffer area in the second-stage memory 117, DES processing of the word can be performed, i.e., the respective words can be sequentially DES processed. In other words, it is possible to proceed with DES processing without waiting for storage of the entire packet to be processed.

[Second Embodiment]

Next, the second embodiment of the present invention is explained below. In the second embodiment, the present invention is applied to a system which performs encryption and decryption in the DES-ECB mode.

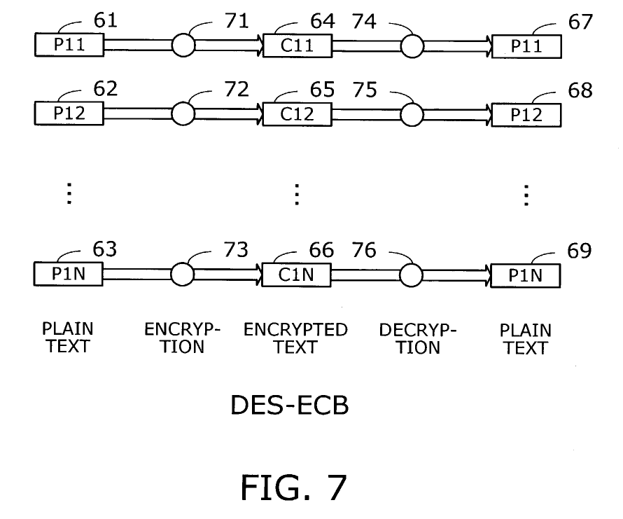

FIG. 7 is a diagram for explaining operations in the DES-ECB mode. In FIG. 7, plain-text data is divided into N words 61, 62 & 63, where N is a natural number. In this example, the contents of the first word 61 is denoted by “P11,” the contents of the second word 62 is denoted by “P12,” and the contents of the last word 63 is denoted by “P1N.”

When a plain text is encrypted, the first word 61 having the contents “P11” is encrypted by an encryption unit 71, so that an encrypted word 64 having the content “C11” is generated.

The second word 62 having the contents “P12” is encrypted by an encryption unit 72, so that an encrypted word 65 having the content “C12” is generated.

Similarly, encryption of the respective words is performed. Finally, the Nth word 63 having the contents “P1N” is encrypted by an encryption unit 73, so that an encrypted word 66 having the content “C1N” is generated.

The encrypted data 64, 65, and 66 constitute an encrypted text. When the encrypted text is converted (decrypted) to a plain text, the first data 64 having the contents “C11” is decrypted by a decryption unit 74, so that a decrypted word 67 having the content “P11” is generated.

In addition, the second data 65 having the contents “C12” is decrypted by a decryption unit 75, so that a decrypted word 68 having the content “P12” is generated.

Similarly, decryption of the respective words is performed. Finally, the Nth data 66 having the contents “C1N” is decrypted by a decryption unit 76, so that a word 69 having the content “P1N” is generated.

The contents of a plain text which is constituted by the words 67, 68, and 69 generated as above are identical to the contents of the plain text constituted by the words 61, 62, and 63.

Thus, it is possible to perform encryption/decryption processing on a word-by-word basis. Since, in the DES-ECB mode, processing of each word is independently performed, and no operation is based on linkage between words, DES processing of each word can be performed in parallel, so that the processing can be performed at high speed.

A system realizing the second embodiment can have a construction similar to the system construction of the first embodiment illustrated in FIG. 3. Hereinbelow, details of the second embodiment are explained based on the system construction of FIG. 3 except that each of the VPN apparatuses 100 and 200 illustrated in FIG. 3 is replaced with a VPN apparatus in the second embodiment. The hardware construction of the VPN apparatus in the second embodiment is almost similar to the hardware construction in the first embodiment illustrated in FIG. 4. However, the secret-data-protection memory module 110 illustrated in FIG. 4 is replaced with a secret-data-protection memory module which performs processing in the DES-ECB mode.

In the following explanations, the same reference numerals as FIGS. 3 and 4 are used except for the secret-data-protection memory module. (In addition, the third and following embodiments are also explained in similar manners.)

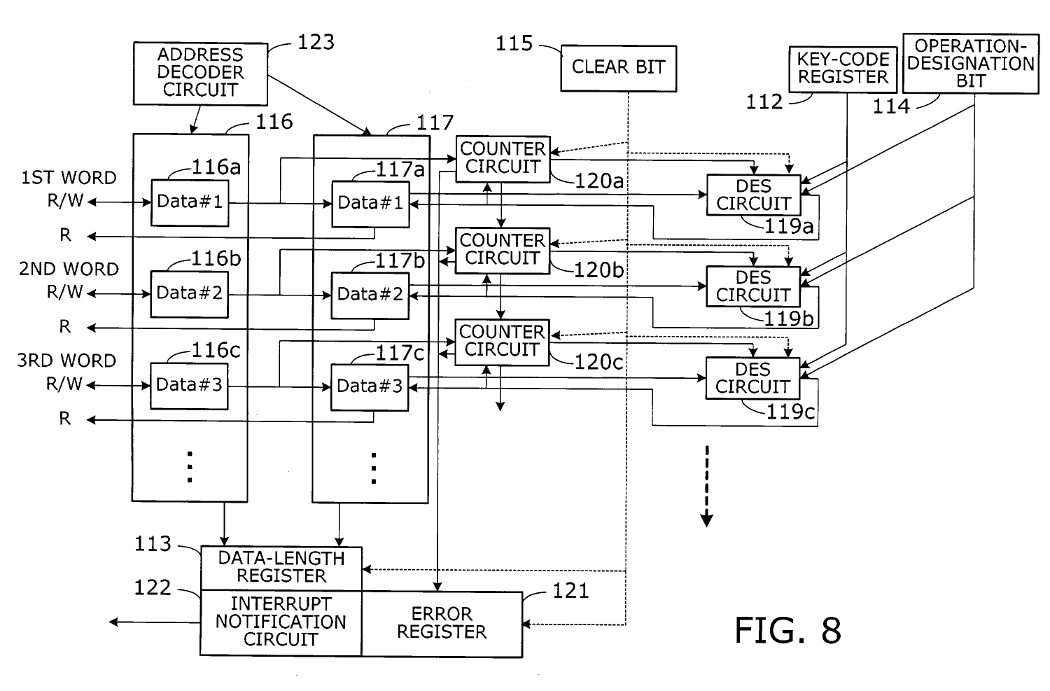

FIG. 8 is a diagram illustrating an exemplary construction of the secret-data-protection memory module in the second embodiment. The construction of the memory module having a function for protecting secrecy in the DES-ECB mode is almost similar to the construction in the first embodiment illustrated in FIG. 5. Therefore, in FIG. 8, the same elements as FIG. 5 respectively bear the same reference numerals as FIG. 5, and the same explanations are not repeated.

The memory module of FIG. 8 is different from the memory module of FIG. 5 in that the memory module of FIG. 8 does not include the IV register 111 and the exclusive-logical-sum circuits 118a, 118b, 118c, . . . illustrated in FIG. 5. Therefore, in FIG. 8, data in the buffer areas 117a, 117b, 117c, . . . are directly inputted into the respectively corresponding DES circuits 119a, 119b, 119c, . . . . In the second embodiment, the DES circuits 119a, 119b, 119c, . . . may also be realized by a common circuit. Thus, the DES processing is sequentially performed from the first word.

The functions of the elements illustrated in FIG. 8 are respectively similar to the functions of the elements in the memory module having a function for protecting secret data in the DES-ECB mode as illustrated in FIG. 5, except that the DES circuits 119a, 119b, 119c, . . . in FIG. 8 perform DES processing of words stored in the buffer areas 117a, 117b, 117c, . . . in the second-stage memory 117, instead of the logical calculation results of the exclusive-logical-sum circuits.

Next, the respective functions of the secret-data-protection memory module having the above construction are explained, although only portions of the memory module which perform different processing from FIG. 5 are explained, and the explanations of the same elements as FIG. 5 are not repeated.

The second embodiment is different from the first embodiment in the “Setting of IV and Key Code” in step S2 and the “DES Processing” in step S4. The second embodiment is identical to the first embodiment in the other processing for “Initialization by Clear Bit 115” in step S1, “Operational Setting to Encryption or Decryption (Conversion to Plain Text)” in step S3, “Setting of Length of Processed Data” in step S5, “Reading of Encrypted or Decrypted Data by Second-stage Memory 117” in step S6, and “Error Notification on Occurrence of Error” in step S7.

[Step S2a] Setting of Key Code

Since the IV (initial vector) is not used in the DES-ECB mode, only setting of a key code is performed, instead of the processing for “Setting of IV and Key Code” in step S2 in the first embodiment. Specifically, the CPU 101 sets in the key-code register 112 a key code used in DES processing. The key code set in the key-code register 112 is inputted into the DES circuits 119a, 119b, 119c.

[Step S4a] DES Processing

The processing for writing in the first-stage memory 116 a packet to be processed and the processing for copying from the first-stage memory 116 into the second-stage memory 117 are performed in similar manners to the first embodiment. Then, timings of processing of words stored in the buffer areas 117a, 117b, 117c, . . . in the second-stage memory 117 are controlled by linkage between the counter circuits 120a, 120b, 120c, . . . . Thus, DES processing is sequentially performed from the first word stored in the buffer area 117a.

When the processing is started, first, the first word stored in the buffer area 117a is inputted into the DES circuit 119a, and the DES circuit 119a performs DES processing according to the value of the operation-designation bit 114. Specifically, when the value of the operation-designation bit 114 is “1,” the DES circuit 119a decrypts the data inputted thereto by using the key code stored in the key-code register 112. In addition, when the value of the operation-designation bit 114 is “0,” the DES circuit 119a encrypts the inputted data by using the key code stored in the key-code register 112. The DES processed data is stored in the buffer area 117a in which the original word is stored.

Next, the next word stored in the buffer area 117b is inputted into the DES circuit 119b, and the DES circuit 119b performs DES processing according to the value of the operation-designation bit 114. Then, the DES processed data is stored in the buffer area 117b in which the original word is stored.

Subsequently, DES processing of the data stored in the second-stage memory 117 is performed on a word-by-word basis. Every time DES processing of a word is performed, the processed data is stored in a buffer area in the second-stage memory 117 in which the original word is stored.

As explained above, encryption/decryption processing in the DES-ECB mode is performed. It is possible to simplify the internal construction of the secret-data-protection memory module by performing the encryption/decryption processing in the DES-ECB mode.

[Third Embodiment]

In the third embodiment, encryption or decryption is performed by the 3DES.

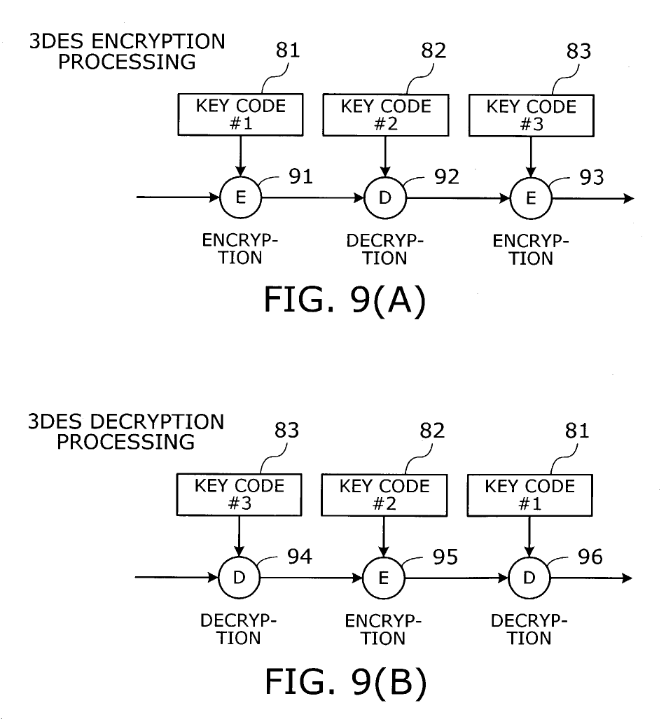

FIG. 9(A) is a diagram illustrating 3DES encryption processing, and FIG. 9(B) is a diagram illustrating 3DES decryption processing.

In the 3DES, DES processing is repeatedly performed three times, and different key codes 81 to 83 are used for the three times of DES processing.

In the 3DES encryption processing, first, encryption processing 91 is performed by using the key code 81 having a value “KEY CODE #1.” Next, decryption processing 92 is performed by using the key code 82 having a value “KEY CODE #2.” Finally, encryption processing 93 is performed by using the key code 83 having a value “KEY CODE #3.” Thus, triply DES processed, strongly encrypted data is obtained.

In decryption processing (i.e., in 3DES decryption processing) which decrypts data encrypted as above, first, decryption processing 94 is performed by using the key code 83 having the value “KEY CODE #3.” Next, encryption processing 95 is performed by using the key code 82 having the value “KEY CODE #2.” Finally, decryption processing 96 is performed by using the key code 81 having the value “KEY CODE #1.” Thus, triply DES processed, encrypted data can be decrypted.

The above processing sequence is common to the CBC mode and the ECB mode.

The secret-data-protection memory module realizing the 3DES is different from the construction of the circuit in the first embodiment illustrated in FIG. 5 in the DES circuits 119a, 119b, 119c, . . . and the key-code register 112. Therefore, only the differences from the first embodiment are explained below.

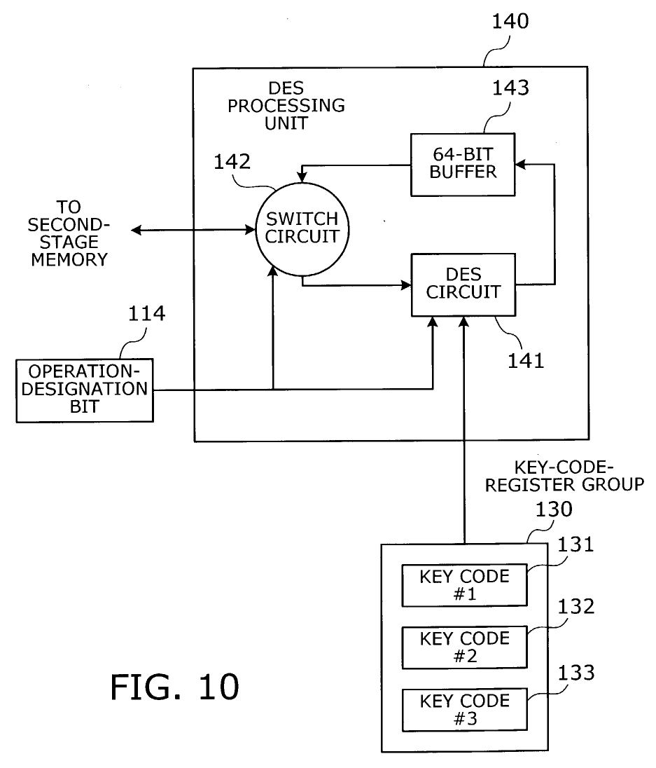

FIG. 10 is a diagram illustrating a construction of a circuit for realizing encryption/decryption processing in the third embodiment. In the third embodiment, the key-code register 112 illustrated in FIG. 5 is replaced with a key-code-register group 130, and the DES circuit 119a illustrated in FIG. 5 is replaced with a DES processing unit 140.

The key-code-register group 130 includes three key-code registers 131, 132, and 133. In this examples, the value of a key code set in the key-code register 131 is indicated as “KEY CODE #1,” the value of a key code set in the key-code register 132 is indicated as “KEY CODE #2,” and the value of a key code set in the key-code register 133 is indicated as “KEY CODE #3.”

The DES processing unit 140 comprises a DES circuit 141, a switch circuit 142, and a 64-bit buffer 143. The value of the operation-designation bit 114 is inputted into the DES circuit 141 and the switch circuit 142. The values in the key-code registers 131 to 133 in the key-code-register group 130 are inputted into the DES circuit 141. The output of the DES circuit 141 is inputted into the 64-bit buffer 143. The output of the 64-bit buffer 143 is inputted into the switch circuit 142. The output of the switch circuit 142 is inputted into the DES circuit 141.

In addition, the switch circuit 142 is connected to the second-stage memory 117. However, in the CBC mode, data from the second-stage memory 117 is inputted into the switch circuit 142 through the exclusive-logical-sum circuit 118a, while data outputted from the switch circuit 142 is directly inputted into the second-stage memory 117.

The DES circuit 141 performs DES processing three times according to the value set in the operation-designation bit 114.

For example, when the value of the operation-designation bit 114 is “0,” the DES circuit 141 performs the DES processing in the order of encryption, decryption, and encryption. In the first encryption processing, data inputted from the switch circuit 142 is encrypted by using the value “KEY CODE #1” set in the key-code register 131. In the decryption processing, data inputted from the switch circuit 142 is decrypted by using the value “KEY CODE #2” set in the key-code register 132. In the second encryption processing, data inputted from the switch circuit 142 is encrypted by using the value “KEY CODE #3” set in the key-code register 133.

On the other hand, when the value of the operation-designation bit 114 is “1,” the DES circuit 141 performs the DES processing in the order of decryption, encryption, and encryption. In the first decryption processing, data inputted from the switch circuit 142 is decrypted by using the value “KEY CODE #3” set in the key-code register 133. In the encryption processing, data inputted from the switch circuit 142 is encrypted by using the value “KEY CODE #2” set in the key-code register 132. In the second decryption processing, data inputted from the switch circuit 142 is decrypted by using the value “KEY CODE #1” set in the key-code register 131.

Every time DES processing is completed, the DES circuit 141 stores the result of the DES processing in the 64-bit buffer 143, which provides a storage area for storing data obtained as a result of DES processing performed by the DES circuit 141.

The switch circuit 142 is a circuit for controlling input into the DES circuit 141. When a signal for starting 3DES processing is outputted, first, the switch circuit 142 inputs into the DES circuit 141 a calculation result of an exclusive logical sum of data outputted from the corresponding buffer area 117a in the second-stage memory 117. Next, when the switch circuit 142 confirms that a result of DES processing is stored in the 64-bit buffer 143, the switch circuit 142 inputs into the DES circuit 141 the data stored in the 64-bit buffer 143.

Subsequently, when the switch circuit 142 confirms that a result of DES processing is stored in the 64-bit buffer 143, the switch circuit 142 again inputs into the DES circuit 141 the data stored in the 64-bit buffer 143. Thereafter, when the switch circuit 142 confirms that a result of DES processing is stored in the 64-bit buffer 143, the switch circuit 142 yet again inputs into the DES circuit 141 the data stored in the 64-bit buffer 143. Subsepuentry, when the switch circuit 142 confirms that a result of DES processing is stored in the 64-bit buffer 143, the switch circuit 142 outputs the data stored in the 64-bit buffer to the buffer area 117a of the second-stage memory 117.

In addition to the replacement of the DES circuit 119a with the DES processing unit 140, each of the DES circuits 119b to 119c is also replaced with a circuit similar to the DES processing unit 140.

In the secret-data-protection memory module having the above construction, for example, when a raw packet to be encrypted is stored in the second-stage memory 117, a word stored in the buffer area 117a is supplied to the 118a, which performs logical calculation based on the word, and the calculation result is inputted into the DES circuit 141 through the switch circuit 142. The DES circuit 141 encrypts a word inputted thereto by using the value “KEY CODE #1,” and stores the encrypted word in the 64-bit buffer 143.

Then, the above data stored in the 64-bit buffer 143 is inputted into the DES circuit 141 through the switch circuit 142. The DES circuit 141 decrypts the word inputted thereto by using the value “KEY CODE #2,” and stores the decrypted word in the 64-bit buffer 143.

Thereafter, the above data stored in the 64-bit buffer 143 is inputted into the DES circuit 141 through the switch circuit 142. The DES circuit 141 encrypts the word inputted thereto by using the value “KEY CODE #3,” and stores the encrypted word in the 64-bit buffer 143. The above data stored in the 64-bit buffer 143 is outputted to the second-stage memory 117 through the switch circuit 142.

Thus, a raw packet is encrypted, and the encrypted packet is stored in the second-stage memory 117.

When an encrypted packet to be decrypted is stored in the second-stage memory 117, decryption based on the value “KEY CODE #3,” encryption based on the value “KEY CODE #2,” and decryption based on the value “KEY CODE #1” are performed, so that a raw packet generated by the decryption is stored in the second-stage memory 117.

Thus, it is possible to perform encryption or decryption of a packet stored in the second-stage memory 117 by the 3DES.

[Fourth Embodiment]

In the fourth embodiment, an example of a secret-data-protection memory module which can change the mode of encryption or decryption is provided. In this embodiment, one of the following four modes of encryption or decryption can be selectively used.

DES-CBC mode

DES-ECB mode

3DES-CBC mode

3DES-ECB mode

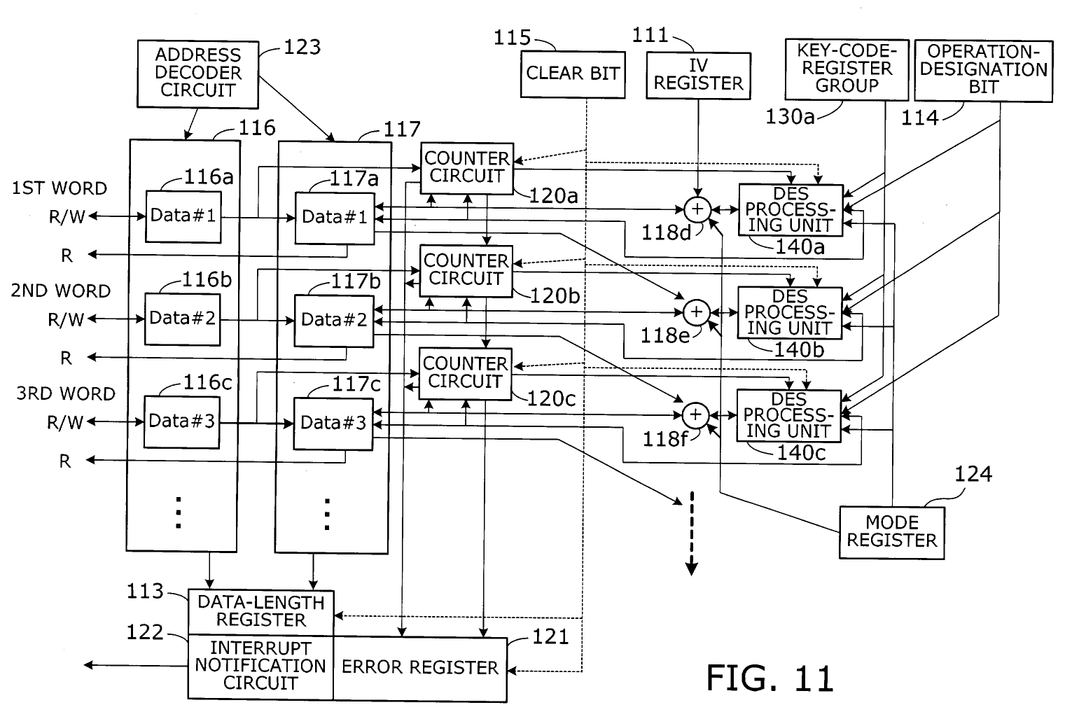

FIG. 11 is a diagram illustrating an exemplary construction of the secret-data-protection memory module in the fourth embodiment. The construction illustrated in FIG. 11 is almost identical to the construction in the first embodiment illustrated in FIG. 5. Therefore, in FIG. 11, the same elements as FIG. 5 respectively bear the same reference numerals as FIG. 5, and the same explanations are not repeated.

The first difference of the fourth embodiment from the first embodiment is that a mode register 124 is added. The mode register 124 is a storage area in which a value designating a mode of encryption/decryption processing. The value in the mode register 124 is set by the CPU 101. For example, “0” is set in the mode register 124 in the DES-CBC mode, “1” is set in the mode register 124 in the DES-ECB mode, “2” is set in the mode register 124 in the 3DES-CBC mode, and “3” is set in the mode register 124 in the 3DES-ECB mode.

In addition, the DES circuits 119a, 119b, 119c, . . . in FIG. 5 are replaced with DES processing units 140a, 140b, 140c, . . . . The internal constructions of the DES processing units 140a, 140b, 140c, . . . are almost identical to the DES processing unit 140 in the third embodiment illustrated in FIG. 10. However, the value of the mode register 124 is inputted into the DES processing units 140a, 140b, 140c, . . . , each of which has a function of determining a mode of the DES processing or the 3DES processing to be performed.

In the case where the DES processing is executed, the first DES processing is performed by the DES circuit, and the processing result is stored in the 64-bit buffer. Then, the switch circuit outputs the contents of the 64-bit buffer to the second-stage memory 117. The sequence of processing in the case of the 3DES processing is as explained with reference to FIG. 10.

Further, the key-code register 112 in FIG. 5 is replaced with a key-code-register group 130a, which has an internal construction similar to the key-coderegister group 130 in the third embodiment illustrated in FIG. 10. That is, the key-code-register group 130a includes three key-code registers, and a key code is set in each of the three registers.

Furthermore, each of the exclusive-logical-sum circuits 118d, 118e, 118f, . . . has a function of determining whether or not logical calculation is necessary by referring to the value of the mode register 124, as well as the functions of the exclusive-logical-sum circuits 118a, 118b, 118c, . . . in the first embodiment illustrated in FIG. 5. That is, when the DES-CBC mode or the 3DES-CBC mode is designated in the mode register 124, the exclusive-logical-sum circuits 118d, 118e, 118f, . . . perform calculation of exclusive logical sums. On the other hand, when the DES-ECB mode or the 3DES-ECB mode is designated in the mode register 124, the exclusive-logical-sum circuits 118d, 118e, 118f, . . . do not perform calculation of exclusive logical sums, and merely pass data acquired from the second-stage memory 117 to the DES processing units 140a, 140b, 140c, . . . as they are.

In the secret-data-protection memory module having the above construction, a packet stored in the second-stage memory 117 is DES processed on a word-by-word basis. For example, a word stored in the buffer area 117a is inputted into the exclusive-logical-sum circuit 118d. The exclusive-logical-sum circuit 118d refers to the mode register 124. When the CBC mode is designated in the mode register 124, the exclusive-logical-sum circuit 118d calculates an exclusive logical sum of the inputted data and the IV stored in the IV register 111, and passes the calculation result to the DES processing unit 140a. In addition, when the ECB mode is designated in the mode register 124, the exclusive-logical-sum circuit 118d passes data in the buffer area 117a to the DES processing unit 140a as it is.

The DES processing unit 140a refers to the mode register 124. When the DES processing is designated in the mode register 124, the DES processing unit 140a performs DES processing according to the value of the operation-designation bit 114 only once, and stores the processing result in the buffer area 117a. When the 3DES processing is designated in the mode register 124, the DES processing unit 140a repeatedly performs DES processing three times (decryption->encryption->decryption or decryption->encryption->decryption) according to the value of the operation-designation bit 114, and stores the processing result in the buffer area 117a.

Thus, it is possible to perform appropriate encryption or decryption by mode switching in consideration of strength of encryption, processing speed, and the like.

[Fifth Embodiment]

The fifth embodiment provides an example of a secret-data-protection memory module which can perform processing for encryption or decryption on only a portion of the storage area of the second-stage memory.

In many cases, it is required to encrypt or decrypt a specific area of a memory when a secret-data-protection memory module is installed in a VPN apparatus. For example, in the VPN apparatus 100 which receives an encrypted packet 52 through the Internet as illustrated in FIG. 3, it is sufficient to decrypt only the encrypted IP packet 52c in the encrypted packet 52. When the secret-data-protection memory module has a function of performing encryption/decryption processing of a portion of a packet stored in a memory, it is sufficient to DMA transfer the encrypted packet 52 to the secret-data-protection memory module as it is.

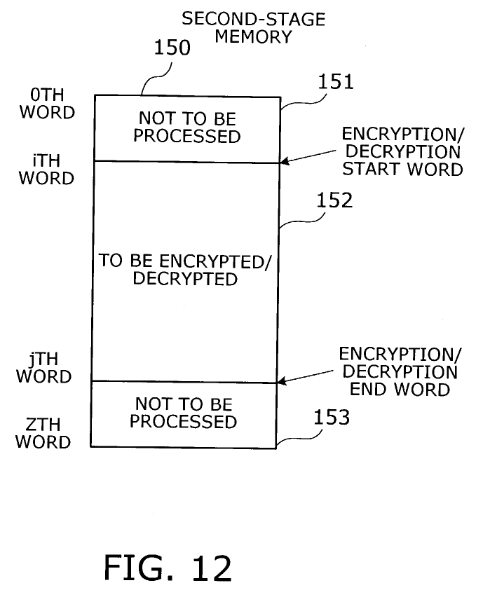

FIG. 12 is a diagram illustrating memory areas in the case where data to be encrypted or decrypted are limited. As illustrated in FIG. 12, the storage area of the second-stage memory 150 is divided into areas 151 and 153 not to be encrypted or decrypted, and an area 152 to be encrypted or decrypted. For example, when a packet having a length of Z words is stored (where Z is a natural number), it is possible to designate the ith word as an encryption or decryption start word, and the jth word as an encryption or decryption end word, where i and j are natural numbers satisfying 0<i<j<Z. Thus, it is possible to designate a range from the ith word to the jth word as the area 152 to be encrypted or decrypted.

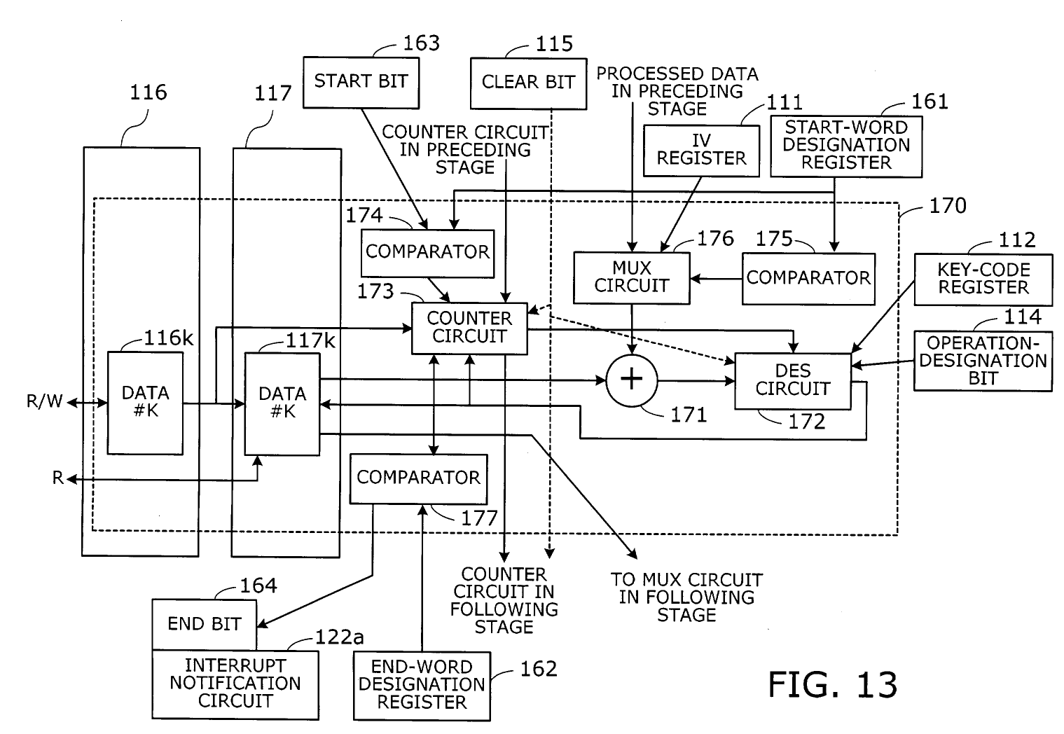

FIG. 13 is a diagram illustrating an exemplary construction of the secret-data-protection memory module in the fifth embodiment. In FIG. 13, an encryption/decryption circuit 170 for performing encryption or decryption of the kth word in the DES-CBC mode is illustrated.

In FIG. 13, the elements indicated outside the encryption/decryption circuit 170 are commonly provided for all words, and the elements indicated inside the encryption/decryption circuit 170 are provided for each word to be processed.

In the fifth embodiment, a start-word designation register 161, an end-word designation register 162, a start bit 163, and an end bit 164 are added to the construction in the first embodiment illustrated in FIG. 5.

The start-word designation register 161 is a register for setting a start word from which encryption or decryption processing is started. The CPU 101 can write and read the start word in and from the start-word designation register 161.

The end-word designation register 162 is a register for setting an end word at which encryption or decryption processing is ended. The CPU 101 can write and read the end word in and from the end-word designation register 162.

The start bit 163 is one-bit data designating a start of processing. The CPU 101 can write and read the start bit 163.

The end bit 164 is one-bit data designating an end of processing. The CPU 101 can write and read the end bit 164.

The interrupt notification circuit 122a is different from the interrupt notification circuit 122 in the first embodiment illustrated in FIG. 5 in that the interrupt notification circuit 122a generates an interrupt signal to the CPU 101 when one-bit data indicating an end of processing is set as the end bit 164.

In FIG. 13, the IV register 111, the key-code register 112, the operation-designation bit 114, and the clear bit 115 respectively have the same functions as the elements having the same names in FIG. 5.

The encryption/decryption circuit 170 for each word includes the kth buffer area 116k in the first-stage memory 116, the kth buffer area 117k in the second-stage memory 117, an exclusive-logical-sum circuit 171, a DES circuit 172, a counter circuit 173, comparators 174, 175, and 177, and a multiplexer (MUX) circuit 176. In FIG. 13, the buffer area 116k, the buffer area 117k, the exclusive-logical-sum circuit 171, the DES circuit 172, and the counter circuit 173 are connected in the same manners as the connections between the buffer area 116a, the buffer area 117a, the exclusive-logical-sum circuit 118a, the DES circuit 119a, and the counter circuit 120a in FIG. 5.

The values of the start-word designation register 161 and the start bit 163 are inputted into the comparator 174, and the output of the comparator 174 is inputted into the counter circuit 173. The value of the start-word designation register 161 is inputted into the comparator 175, and the output of the comparator 175 is inputted into the multiplexer circuit 176. In addition, processed data in the preceding stage (i.e., data in the (k-1)th buffer area in the second-stage memory 117) and the value in the IV register 111 are also inputted into the multiplexer circuit 176, and the output of the multiplexer circuit 176 is inputted into the exclusive-logical-sum circuit 171. The values of the end-word designation register 162 and the counter circuit 173 are inputted into the comparator 177, and the output of the comparator 177 is inputted into the end bit 164.

When one-bit data indicating a start of processing is set in the start bit 163, the comparator 174 compares the start word set in the start-word designation register 161 with a word stored in the buffer area 117k as a constituent of the encryption/decryption circuit 170. When the start word is the word stored in the buffer area 117k, the comparator 174 sends to the counter circuit 173 a signal indicating a start of processing.

The comparator 175 compares the start word set in the start-word designation register 161 with a word stored in the buffer area 117k as a constituent of the encryption/decryption circuit 170. When the start word is the word stored in the buffer area 117k, the comparator 175 sends to the multiplexer circuit 176 a signal indicating that the word stored in the buffer area 117k is the first word.

In response to the signal from the comparator 175, the multiplexer circuit 176 inputs into the exclusive-logical-sum circuit 171 one of the value of the IV register 111 and the processed data in the preceding stage. Specifically, when the signal from the comparator 175 indicates that the word stored in the buffer area 117k is the first word, the multiplexer circuit 176 inputs the value of the IV register 111 into the exclusive-logical-sum circuit 171. When the signal from the comparator 175 indicates that the word stored in the buffer area 117k is not the first word, the multiplexer circuit 176 inputs the processed data in the preceding stage into the exclusive-logical-sum circuit 171.

When the word in the end-word designation register 162 (setting the end word at which encryption or decryption processing is ended) is the word in the buffer area 117k, the comparator 177 notifies the end bit 164 and the counter circuit 173 of the end of processing when the comparator 177 receives a signal from the counter circuit 173, and data processing of the word is completed.

The counter circuit 173 is set to “0” in the initial state, and is set to “1” when a word is copied from the buffer area 116k in the first-stage memory 116 into the buffer area 117k in the second-stage memory 117. In addition, when the comparator 174 indicates that the word in the buffer area 117k is the start word, or when the value of the counter circuit in the preceding stage becomes “2,” the counter circuit 173 instructs the DES circuit 172 to start DES processing. Further, when data processed by the DES circuit 172 is stored in the buffer area 117k, the counter circuit 173 sets the value of the counter circuit to “2.”

The operations of the DES circuit 172 are identical to the operations of the DES circuits 119a, 119b, 119c, . . . in the first embodiment illustrated in FIG. 5.

Next, details of the processing of the counter circuit 173 are explained.

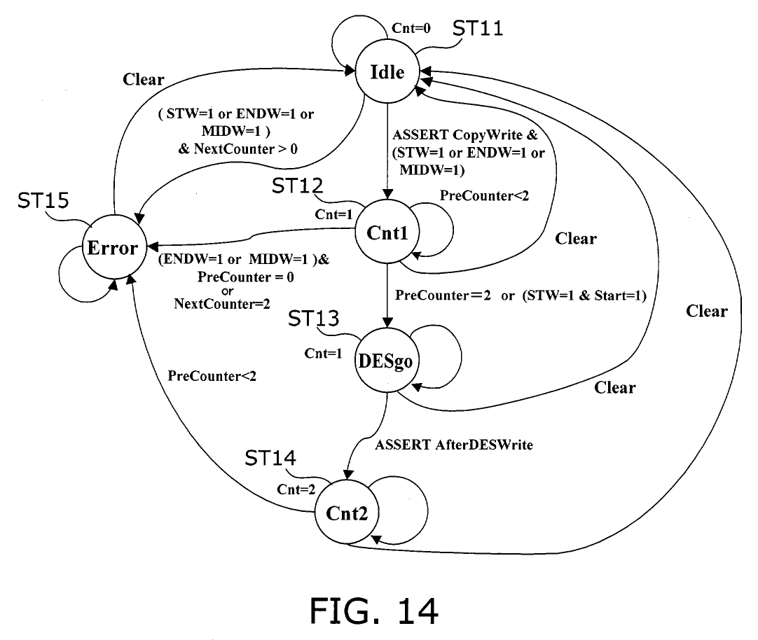

FIG. 14 is a diagram illustrating a state machine of the counter circuit. As illustrated in FIG. 14, the counter circuit 173 can have five states. The first (Idle) state ST11 is an idle state, and the value of the counter is “0” in this state. The second (Cnt1) state ST12 is a state in which copying of a word is completed, and the value of the counter is “1” in this state. The third (DESgo) state ST13 is a state in which a DES-processing start signal is outputted, and the value of the counter is “1” in this state. The fourth (Cnt2) state ST14 is a state in which DES processing is completed, and the value of the counter is “2” in this state. The fifth (Error) state ST15 is a state in which an error occurs, and the value of the counter in this state can be any value.

The signals inputted into the counter circuit 173 are as follows.

CopyWrite: A write signal for copying data from the first-stage memory 116 into the second-stage memory 117

AfterDESWrite: A write signal for storing DES processed data in the second-stage memory 117

NextCounter[1:0]: A count value of a counter circuit in the next stage

PreCounter[1:0]: A count value of a counter circuit in the preceding stage

Clear: A clear signal

SystemClock: A clock signal

STW: A signal indicating that a word stored in a buffer area in the same stage is a start word

ENDW: A signal indicating that a word stored in a buffer area in the same stage is an end word

MIDW: A signal indicating that a word stored in a buffer area in the same stage is between a start word and an end word, and is neither the start word nor the end word

Start: A processing start signal

In addition, the signals outputted from the counter circuit 173 are as follows.

ErrorSignal: An error signal

DESgo: A signal for starting execution of DES processing

Cnt[1:0]: A counter value

EndSignal: A signal notifying that completion of processing up to an end word

The state of the counter circuit 173 transitions according to the above input and output signals.

First, in the first state ST11, “0” is set as the counter value. The first state ST11 is maintained while the count value is “0.” However, when the CopyWrite signal is asserted in the first state ST11, and one of the STW, ENDW, and MIDW signals is asserted to be “1,” the counter circuit 173 transitions to the second state ST12. When one of the STW, ENDW, and MIDW signals is asserted to be “1,” and the signal (NextCounter[1:0]) indicating the count value of a counter circuit in the next stage becomes greater than 0 in the first state ST11, the counter circuit transitions from the first state ST11 to the fifth state ST15.

In the second state ST12, “1” is set as the counter value. When the count value (PreCounter) of a counter circuit in the preceding stage is less than two, the second state ST12 is maintained. When the count value (PreCounter) of the counter circuit in the preceding stage becomes two in the second state ST12, or when one of the STW signal and the Start signal becomes “1,” the counter circuit transitions to the third state ST13. When the clear signal (Clear) is outputted in the second state ST12, the counter circuit transitions to the first state ST11. When one of the ENDW and MIDW signals is asserted to be “1” and the count value (PreCounter) of the counter circuit in the preceding stage becomes “0,” or when the count value (NextCounter) of the counter circuit in the next stage becomes “2,” the counter circuit transitions to the fifth state ST15.

In the third state ST13, processing for outputting the signal (DESgo) for starting execution of DES processing is performed. In response to the output of this signal (DESgo), the DES processing is executed by a DES circuit corresponding to the counter circuit (i.e., in the same stage as the counter circuit) . When the DES processing is executed, and a write (AfterDESWrite) signal for writing DES processed data in the second-stage memory 117 is asserted, the counter circuit transitions to the fourth state ST14. When the clear (Clear) signal is outputted in the third state ST13, the counter circuit transitions to the first state ST11.

In the fourth state ST14, “2” is set as the counter value. When the clear (Clear) signal is outputted in the fourth state ST14, the counter circuit transitions to the first state ST11. When the count value (PreCounter) of the counter circuit in the preceding stage becomes less than two, the counter circuit transitions to the fifth state ST15.

In the fifth state ST15, error processing is executed. When the clear (Clear) signal is outputted in the fifth state ST15, the counter circuit transitions to the first state ST11.

In the VPN apparatus in which the above secret-data-protection memory module is installed, the processing for “Initialization by Clear Bit 115” in step S1, the processing for “Setting of IV and Key Code” in step S2, and the processing for “Operational Setting to Encryption or Decryption (Conversion to Plain Text)” in step S3 are performed in similar manners to the first embodiment. Although DES processing is thereafter performed, details of the DES processing are different between the first and fifth embodiments.

[Step S4b] DES Processing

The CPU 101 writes a packet to be processed in the first-stage memory 116. The packet is written word by word (in units of 64 bits) into the buffer areas 116a, 116b, 116c, . . . in the first-stage memory 116. The data length (the number of words) of the stored packet is set in the 32 more significant bits of the data-length register 113.

The packet stored in the first-stage memory 116 is immediately copied into the second-stage memory 117. Then, the CPU 101 recognizes the start word and the end word of data to be DES processed. In addition, the CPU 101 sets a value indicating the start word in the start-word designation register 161, and a value indicating the end word in the end-word designation register 162.

Thereafter, the CPU 101 sets a value indicating a start of DES processing in the start bit 163. Then, the word-by-word processing of data stored in the second-stage memory 117 is started by the encryption/decryption circuit.

As an example, the operations of the encryption/decryption circuit 170 in the case where the kth word is the start word are explained below.

The comparator 174 in the encryption/decryption circuit 170 corresponding to the kth word determines whether or not the kth word is the start word. When yes is determined, the comparator 174 sends an STW signal to the counter circuit 173 so that the counter circuit 173 is informed that the kth word is the start word. Then, the counter circuit 173 outputs the DESgo signal to the DES circuit 172.

In addition, when the comparator 175 determines that the kth word is the start word, the multiplexer circuit 176 passes to the exclusive-logical-sum circuit 171 the IV (initial vector) which is set in the IV register 111. Then, the exclusive-logical-sum circuit 171 calculates an exclusive logical sum of the IV and the kth word stored in the buffer area 117k, and the exclusive logical sum is inputted into the DES circuit 172.

The DES circuit 172 performs DES processing (encryption or decryption) designated by the operation-designation bit 114, in response to the DESgo signal outputted from the counter circuit 173, where a key code stored in the key-code register 112 is used in the DES processing. The result of the DES processing is stored in the buffer area 117k.

Then, the AfterDESWrite signal is inputted into the counter circuit 173, and “2” is set in the counter circuit 173. The value in the counter circuit 173 is inputted into a counter circuit in an encryption/decryption circuit in the next stage, and DES processing of a word in the next stage is performed. Thereafter, word-by-word DES processing is performed until processing of the end word is completed.

Next, the operations of the encryption/decryption circuit 170 in the case where the kth word is the end word are explained below.

The comparator 174 in the encryption/decryption circuit 170 corresponding to the kth word determines whether or not the kth word is the start word. When no is determined, the counter circuit 173 waits until the value of the counter circuit in the encryption/decrypton circuit 170 in the preceding stage becomes “2.” When the value of the counter circuit in the preceding stage becomes “2,” the counter circuit 173 outputs the DESgo signal to the DES circuit 172.

In addition, when the comparator 175 determines that the kth word is not the start word, the multiplexer circuit 176 passes a DES processed word in the preceding stage to the exclusive-logical-sum circuit 171. Then, the exclusive-logical-sum circuit 171 calculates an exclusive logical sum of the DES processed word in the preceding stage and the kth word stored in the buffer area 117k, and the exclusive logical sum is inputted into the DES circuit 172.

The DES circuit 172 performs DES processing (encryption or decryption) designated by the operation-designation bit 114, in response to the DESgo signal outputted from the counter circuit 173, where the key code stored in the key-code register 112 is used in the DES processing. The result of the DES processing is stored in the buffer area 117k.

Then, the AfterDESWrite signal is inputted into the counter circuit 173, and “2” is set in the counter circuit 173. When the value of the counter circuit 173 becomes “2,” the comparator 177 refers to the end word set in the end-word designation register 162, and determines whether or not the kth word is the end word. When it is determined that the kth word is the end word, the comparator 177 outputs the EndSignal signal indicating that the processing up to the end word is completed, and a flag indicating completion of processing is set in the end bit 164. Then, the interrupt notification circuit 122 outputs an interrupt signal to the CPU 101.

Thus, it is possible to perform encryption/decryption processing of a portion of data transferred to the secret-data-protection memory module.

[Sixth Embodiment]

The sixth embodiment provides an example of a VPN apparatus in which a secret-data-protection memory module is installed. In the secret-data-protection memory module, the functions in the aforementioned embodiments are combined. That is, in the secret-data-protection memory module in the sixth embodiment, it is possible to select the mode of the encryption or decryption by mode switching as indicated in the fourth embodiment (which includes the functions of the first to third embodiments) , and perform encryption/decryption processing of a portion of data transferred to the secret-data-protection memory module.

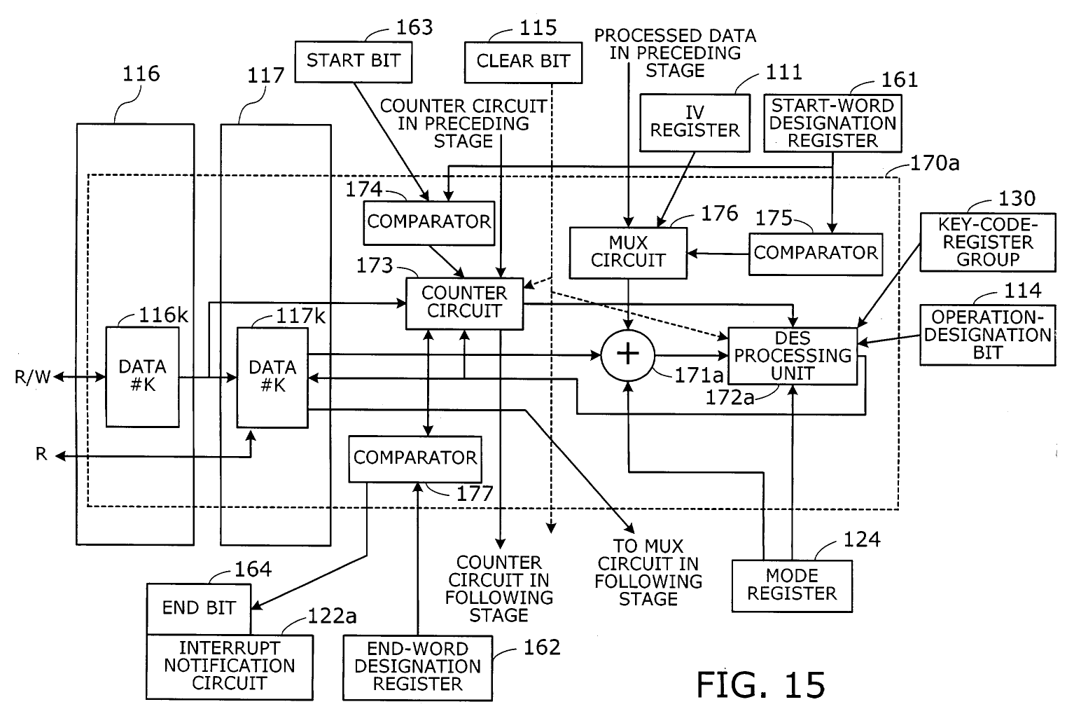

FIG. 15 is a diagram illustrating an exemplary construction of the secret-data-protection memory module in the sixth embodiment. In FIG. 15, an encryption/decryption circuit 170a corresponding to each word in the secret-data-protection memory module in the sixth embodiment is illustrated. In FIG. 15, the same elements as the secret-data-protection memory module in the fifth embodiment illustrated in FIG. 13 respectively bear the same reference numerals as FIG. 13, and the same explanations are not repeated.

In the sixth embodiment, a mode register 124 is added to the construction in the fifth embodiment illustrated in FIG. 13. In addition, the key-code register 112 in FIG. 13 is replaced with a key-code-register group 130, the DES circuit 172 in the encryption/decryption circuit 170 in FIG. 13 is replaced with a DES processing unit 172a in the encryption/decryption circuit 170a, and the exclusive-logical-sum circuit 171 is replaced with an exclusive-logical-sum circuit 171a. The DES processing unit 172a has the same functions as the DES processing units 140a, 140b, 140c, . . . in the fourth embodiment illustrated in FIG. 11, and the exclusive-logical-sum circuit 171a has the same functions as the exclusive-logical-sum circuits 118d, 118e, 118f, . . . in the fourth embodiment illustrated in FIG. 11.

When the secret-data-protection memory module has the above construction, it is possible to select the mode of encryption or decryption by mode switching, and perform encryption/decryption processing of a portion of data transferred to the secret-data-protection memory module.

Hereinbelow, details of processing in an exemplary case of the sixth embodiment are explained. In the exemplary case, a VPN apparatus in which a secret-data-protection memory module is installed transmits and receives data by using a DES-CBC tunnel mode.

First, a sequence for generation of an encrypted packet is explained.

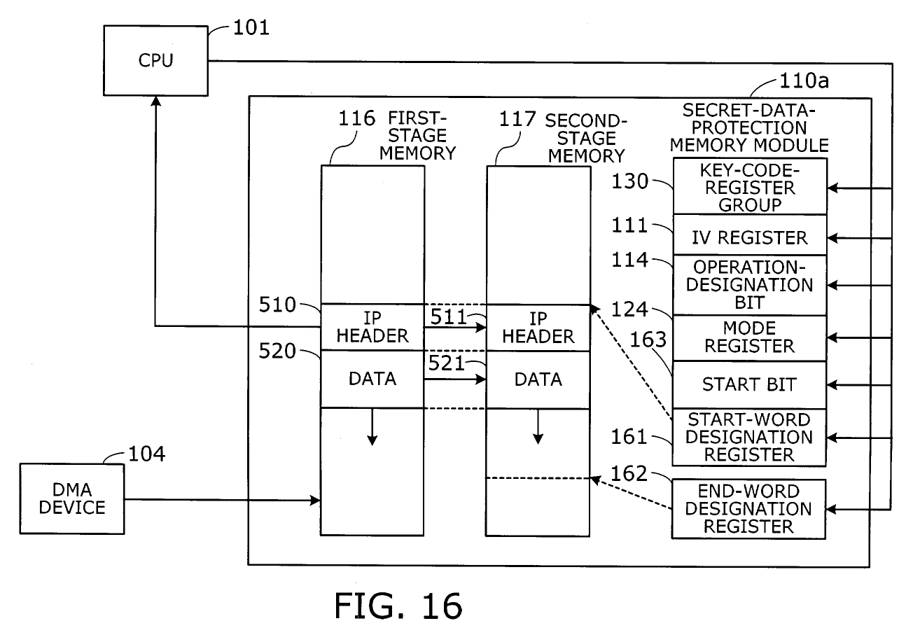

FIG. 16 is a diagram illustrating a state during reception of a raw packet. When a raw packet is received, the raw packet is DMA transferred from the DMA device 104 to a secret-data-protection memory module 110a, where the raw packet is constituted by an IP header 510 and data 520. The DMA transferred packet is stored in the first-stage memory 116 in the secret-data-protection memory module 110a. In addition, the packet stored in the first-stage memory 116 is instantaneously copied into the second-stage memory 117 on a word-by-word basis. Thus, a duplicate of the raw packet (constituted by an IP header 511 and data 521) is stored in the second-stage memory 117.

During the above operations, the CPU 101 analyzes the IP header 510 stored in the first-stage memory 116, and recognizes the length of the packet. In addition, the CPU 101 determines whether the packet is to be encrypted or decrypted, based on the destination of the raw packet and the like. For example, as illustrated in FIG. 3, packets transferred from the intranet 41 to the Internet 42 are to be encrypted. On the other hand, packets transferred from the Internet 42 to the intranet 43 are to be decrypted.

When the CPU 101 determines that the raw packet is to be encrypted, the CPU 101 sets an IV, key codes, a designation of an operation (encryption) , a mode (DES-CBC), a start word, and an end word in the IV register 111, key-code registers in the key-code-register group 130, the operation-designation bit 114, the mode register 124, the start-word designation register 161, and the end-word designation register 162, respectively, in the secret-data-protection memory module 110a, and thereafter sets the start bit 163. When the start bit is set, the secret-data-protection memory module 110a is instructed to start encryption. Then, the secret-data-protection memory module 110a starts encryption processing on a word-by-word basis. This encryption processing is continued until the end word is processed.

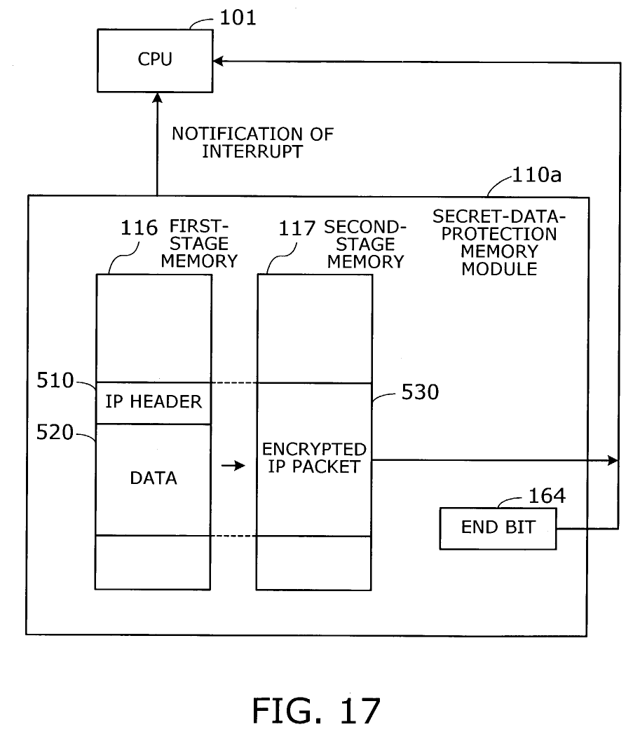

FIG. 17 is a diagram illustrating a state after completion of encryption processing.

In the state illustrated in FIG. 17, encryption processing in the secret-data-protection memory module 110a is completed, and an interrupt notification to the CPU 101 is made. At this time, the CPU 101 confirms the completion of the processing by reading the status of the end bit 164. Thereafter, the CPU 101 reads an encrypted IP packet 530 from the second-stage memory 117, and starts production of authentication data.

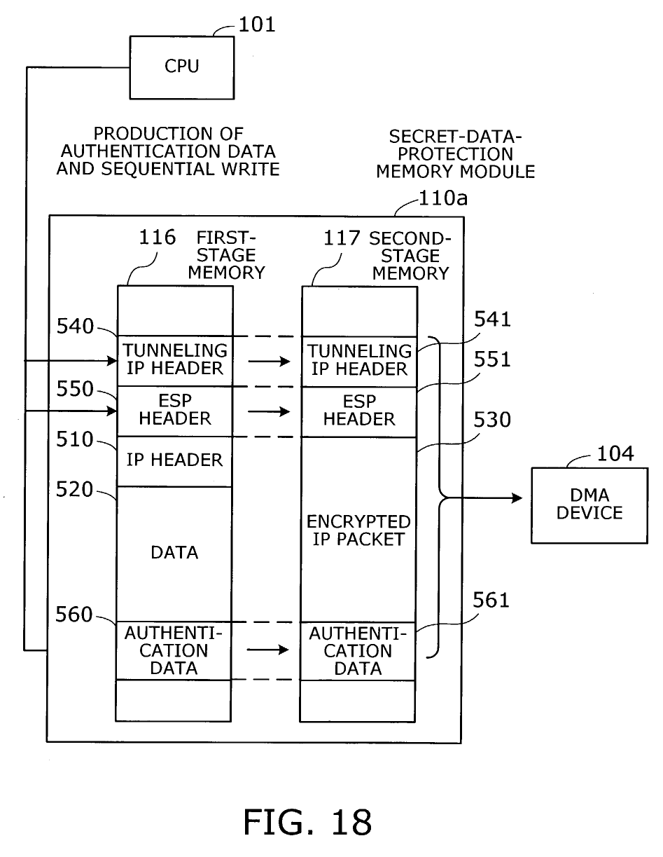

FIG. 18 is a diagram illustrating a state after generation of data in a tunnel mode. In order to transfer an encrypted packet in the tunnel mode, the CPU 101 produces a tunneling IP header 540, an ESP header 550, and authentication data 560, and writes the tunneling IP header 540, the ESP header 550, and the authentication data 560 in the first-stage memory 116. Each of these data written in the first-stage memory 116 are copied into the second-stage memory 117. Thus, a duplicate 541 of the tunneling IP header 540, a duplicate 551 of the ESP header 550, and a duplicate 561 of the authentication data 560 are stored in the second-stage memory 117. When processing for writing all of these data is completed, the DMA device 104 transfers an encrypted packet (constituted by the duplicate 541 of the tunneling IP header 540, the duplicate 551 of the ESP header 550, a duplicate 530 of an encrypted IP packet, and the duplicate 561 of the authentication data 560) to another device (such as an NIC).

Next, a sequence for decryption of an encrypted packet is explained.

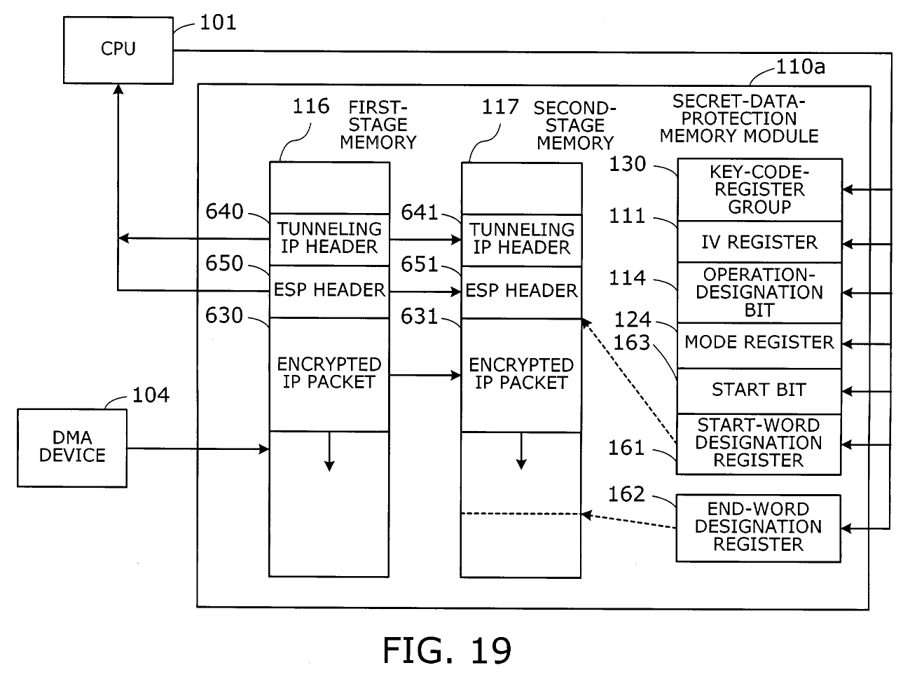

FIG. 19 is a diagram illustrating a state during reception of an encrypted packet. When an encrypted packet is received, the DMA device 104 transfers the encrypted packet by DMA, so that a tunneling IP header 640, an ESP header 650, and an encrypted IP packet 630, and the like constituting the encrypted packet are stored in the first-stage memory 116 in the secret-data-protection memory module 110a, and instantaneously copied into the second-stage memory 117. Thus, a duplicate 641 of the tunneling IP header 640, a duplicate 651 of the ESP header 650, a duplicate 631 of the encrypted IP packet 630, and the like are stored in the second-stage memory 117.

During the above operations, the CPU 101 analyzes the tunneling IP header 640 and the ESP header 650, and recognizes the packet length, an encryption mode, and an encryption key. Then, the CPU 101 sets an IV, key codes, a designation of an operation (decryption), a mode (DES-CBC), a start word (the leading word of the duplicate 631 of the encrypted IP packet 630), and an end word (the last word of the duplicate 631 of the encrypted IP packet 630) in the IV register 111, the key-code registers in the key-code-register group 130, the operation-designation bit 114, the mode register 124, the start-word designation register 161, and the end-word designation register 162, respectively, in the secret-data-protection memory module 110a. Thereafter, the CPU 101 sets a value indicating a start of processing in the start bit 163 so that a start of decryption is designated. Then, the secret-data-protection memory module 110a starts decryption processing on a word-by-word basis. The decryption processing is continued until the last word of the encrypted IP packet is processed.

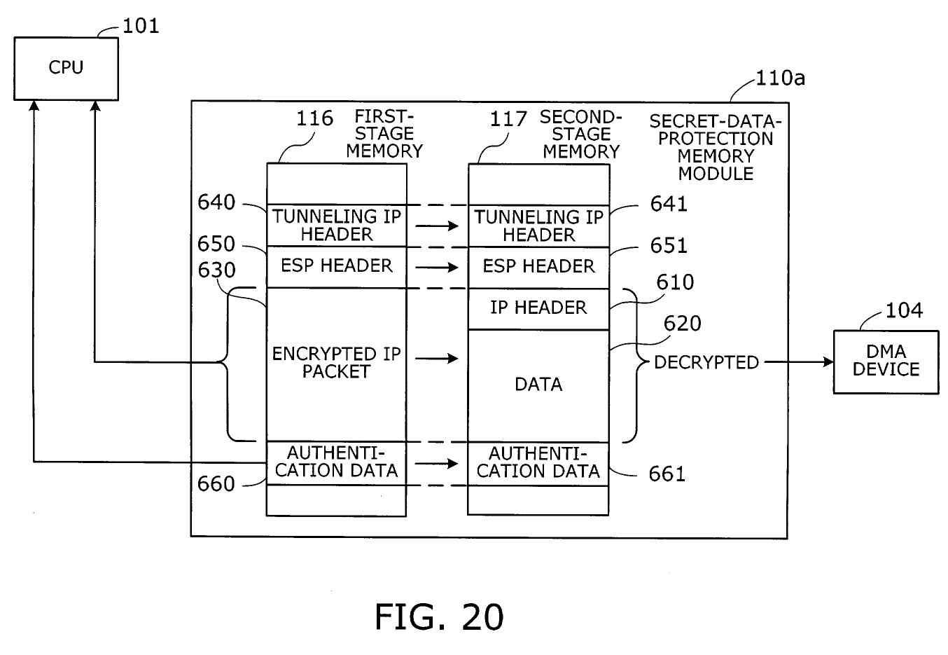

FIG. 20 is a diagram illustrating a state in authentication processing performed during decryption processing. The CPU 101 reads the encrypted IP packet 630, and produces authentication data. Then, the CPU 101 performs authentication by comparing the produced authentication data with the authentication data 660 contained in the encrypted packet, and determining whether or not the produced authentication data coincides with the authentication data 660. Even during the authentication, the decryption processing is performed in the secret-data-protection memory module 110a. When the decryption is completed, a raw packet is DMA transferred by the DMA device 104.

As explained above, in the sixth embodiment of the present invention, processing for transmission and reception of encrypted packets in a VPN apparatus can be efficiently performed.

Hereinbelow, the effect of increasing the processing efficiency by using the VPN apparatuses as the embodiments of the present invention is explained in comparison with a VPN apparatus using a conventional technique.

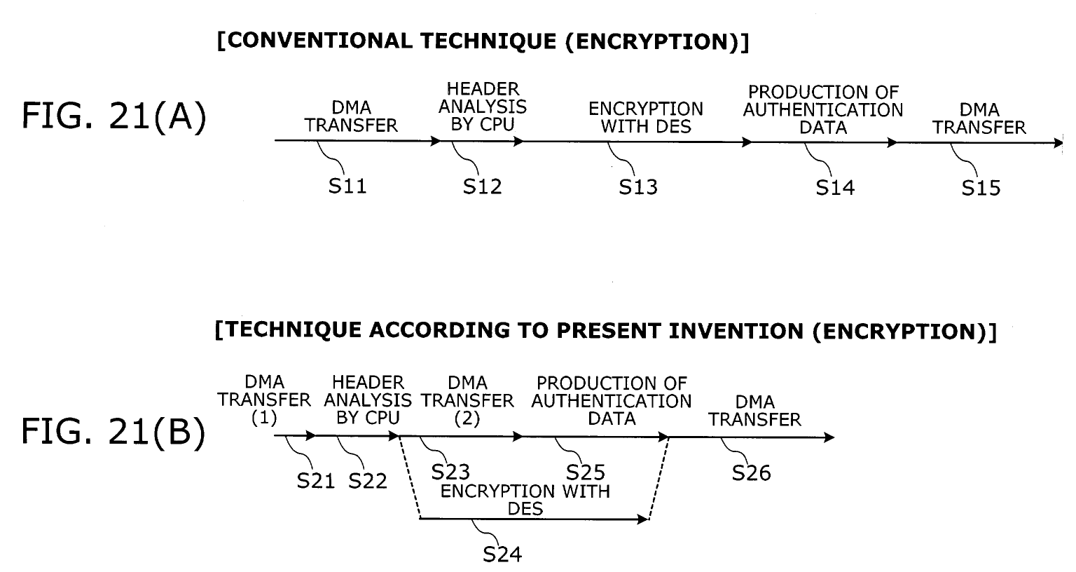

FIG. 21(A) is a diagram illustrating a sequence of encryption processing in the conventional technique for comparison with the technique according to the present invention, and FIG. 21(B) is a diagram illustrating a sequence of encryption processing by the technique according to the present invention for comparison with the conventional technique.

The encryption processing according to the conventional technique is performed in the order of DMA transfer (in step Sll), header analysis by a CPU (in step S12), encryption with DES (in step S13), production of authentication data (in step S14), and DMA transfer (in step S15).

On the other hand, the encryption processing according to the present invention is performed in the order of DMA transfer (1) of IP header (in step S21), header analysis by the CPU (in step S22), DMA transfer (2) (in step S23), parallelized encryption with DES (in step S24), production of authentication data after completion of the DMA transfers (in step S25), and DMA transfer after completion of the encryption and the production of authentication data (in step S26). Since the memory bus is temporarily used by the CPU for the header analysis, the DMA transfer before the encryption is split into the two steps (1) and (2).

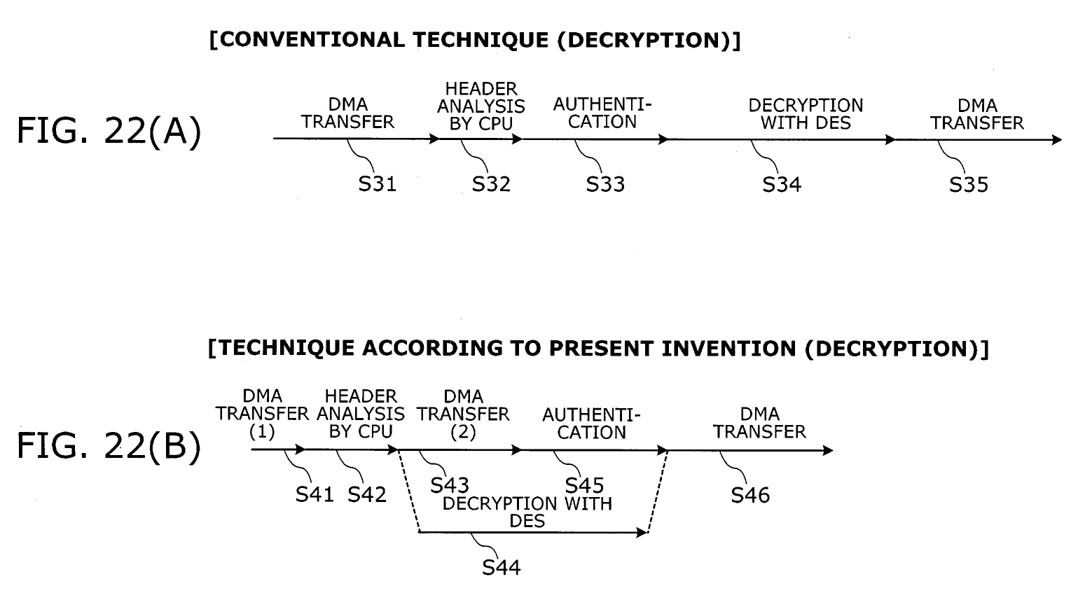

FIG. 22(A) is a diagram illustrating a sequence of decryption processing by a conventional technique for comparison with the technique according to the present invention, and FIG. 22(B) is a diagram illustrating a sequence of decryption processing by the technique according to the present invention for comparison with the conventional technique.

The decryption processing according to the conventional technique is performed in the order of DMA transfer (in step S31), header analysis by a CPU (in step S32), authentication (in step S33), decryption with DES (in step S34), and DMA transfer (in step S35).

On the other hand, the decryption processing according to the present invention is performed in the order of DMA transfer (1) of IP header. (in step S41), header analysis by the CPU (in step S42), DMA transfer (2) (in step S43), parallelized decryption with DES (in step S44), authentication after completion of the DMA transfers (in step S45), and DMA transfer after completion of the decryption and the production of authentication data (in step S46). Since the memory bus is temporarily used by the CPU for the header analysis, the DMA transfer before the decryption is split into the two steps (1) and (2).

As illustrated in FIGS. 21 and 22, in the embodiment of the present invention, DES processing can be parallelized. Therefore, the processing time for encryption or decryption of a packet can be reduced. The numbers of cycles in a conventional VPN apparatus and a VPN apparatus as an embodiment of the present invention are roughly estimated below. The estimation is performed in an exemplary case where a frame having a length of 1,500 bytes is processed. For ease of understanding of calculation results, it is assumed that each of a raw packet and an encrypted packet is constituted by 200 words.

[Conventional Technique (Encryption)]

DMA Transfer: 200×4=800 cycles

Header Analysis: 2,000 cycles

DES Processing: 200×16+200×(4+4)=4,800 cycles

Production of Authentication Data: 3,000 cycles

DMA Transfer: 200×4=800 cycles

Total: 11,400 cycles

[Technique According to Present Invention (Encryption)]

DMA Transfer (1): 3×4=12 cycles (transfer of IP header)

Header Analysis: 2,000 cycles

DMA Transfer (2): 788 cycles

DES Processing: 200×16=3,200 cycles

Production of Authentication Data: 3,000 cycles

DMA Transfer: 200×4=800 cycles

Total: 12+2,000+788+3,000+80 =6,600 cycles

[Conventional Technique (Decryption)]

DMA Transfer: 200×4=800 cycles

Header Analysis: 2,000 cycles

DES Processing: 200×16+200×(4+4)=4,800 cycles

Authentication: 3,000 cycles

DMA Transfer: 200×4=800 cycles

Total: 11,400 cycles

[Technique According to Present Invention (Decryption)]

DMA Transfer (1): 3×4=12 cycles (transfer of IP header)

Header Analysis: 2,000 cycles

DMA Transfer (2): 788 cycles

DES Processing: 200×16=3,200 cycles

Authentication: 3,000 cycles

DMA Transfer: 200×4=800 cycles

Total: 12+2,000+788+3,000+800=6,600 cycles

In addition, in the above estimation, it is assumed that four cycles are necessary for each of an operation of DMA transfer of a word and an operation of reading or writing a word by the CPU.

According to the above estimation, when the secret-data-protection memory module according to the present invention is used, the performance is almost doubled.

[Seventh Embodiment]

In the seventh embodiment, as a memory in a VPN apparatus, a ring buffer is formed with secret-data-protection memory modules so as to increase processing speed.

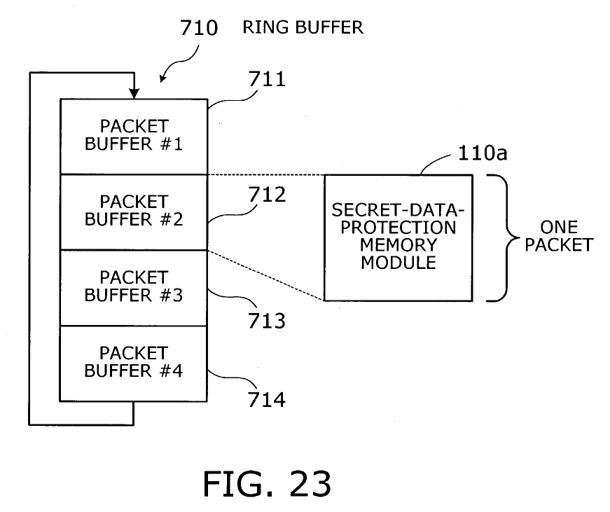

FIG. 23 is a diagram illustrating an exemplary construction of a ring buffer used in the seventh embodiment. As illustrated in FIG. 23, the ring buffer 710 is constituted by a plurality of packet buffers 711 to 714. Each of the plurality of packet buffers 711 to 714 has the same internal construction as the secret-data-protection memory module 110a, for example, in the sixth embodiment.

When the ring buffer 710 is constituted by using the secret-data-protection memory module 110a as above, encryption or decryption processing of each input packet can be parallelized. Thus, the data processing rate of the VPN apparatus increases.

[Eighth Embodiment]

In the eighth embodiment, an ID card in which a secret-data-protection memory module is built in is used for personal authentication.

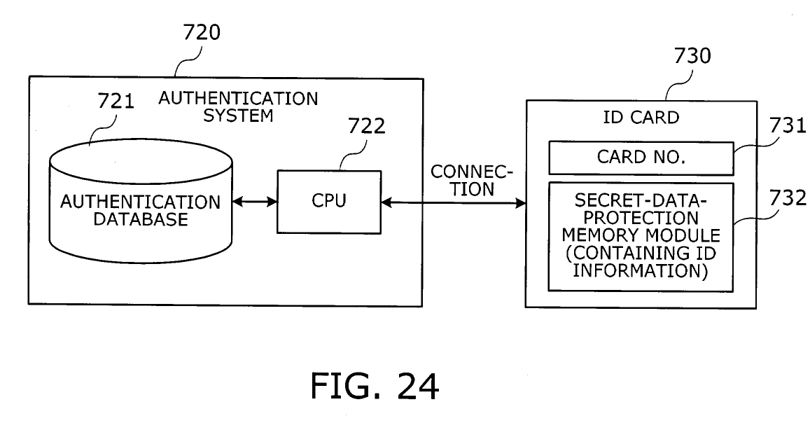

FIG. 24 is a diagram illustrating an example of an ID card used. in the eighth embodiment. As illustrated in FIG. 24, the authentication system 720, which is provided for performing personal authentication, comprises an authentication database 721 and a CPU 722. In the authentication database 721, identification information for a user of each ID card 730 is stored, where the ID card 730 is provided for performing personal authentication.

The ID card 730 comprises a card number (No.) 731 and a secret-data-protection memory module 732. As the card number 731, an identification number for uniquely identifying the ID card 730 by the authentication system 720 is registered. In addition, a key code and identification information are included in the secret-data-protection memory module 732, where the key code is registered in the authentication system 720, and the identification information is encrypted with an IV (initial vector) and provided for identifying a genuine user.

When the ID card 730 is connected to the authentication system 720, the authentication system 720 reads the card number 731 of the ID card 730. Then, the authentication system 720 extracts from the authentication database 721 user information corresponding to the card number 731, and identifies the owner of the ID card 730. When the owner is identified, the authentication system 720 acquires a key code and an IV corresponding to the owner. In addition, the authentication system 720 inputs the acquired key code and IV into the secret-data-protection memory module 732 in the ID card 730. Then, the identification information, which is encrypted, is decrypted in the ID card 730, so that the authentication system 720. can read and interpret the identification information stored in the ID card 730.

Thus, it is possible to identify the genuine user of the ID card 730 with high reliability.

[Ninth Embodiment]

In the ninth embodiment, the secrecy of the eighth embodiment is further improved.

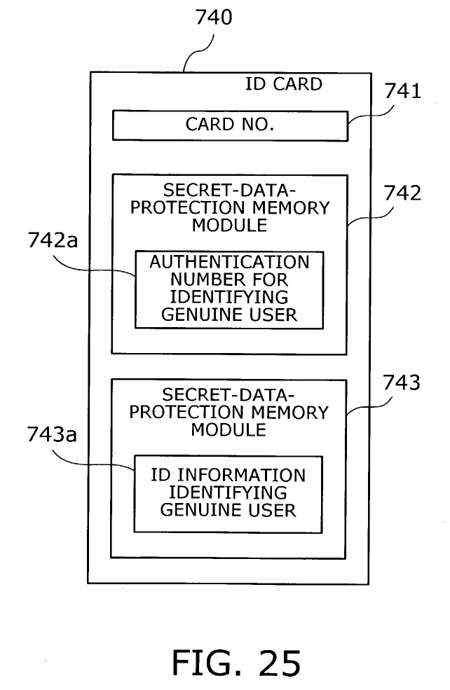

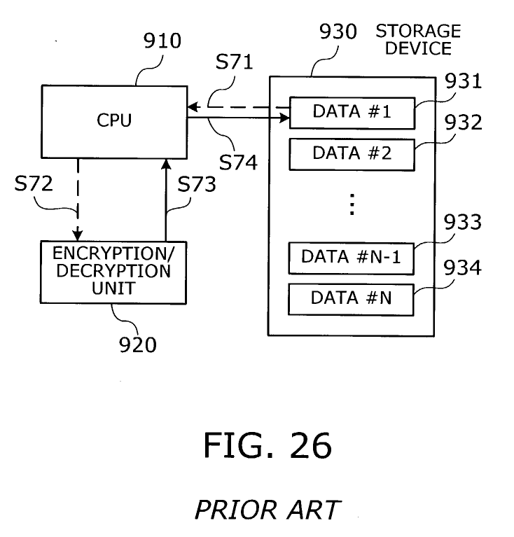

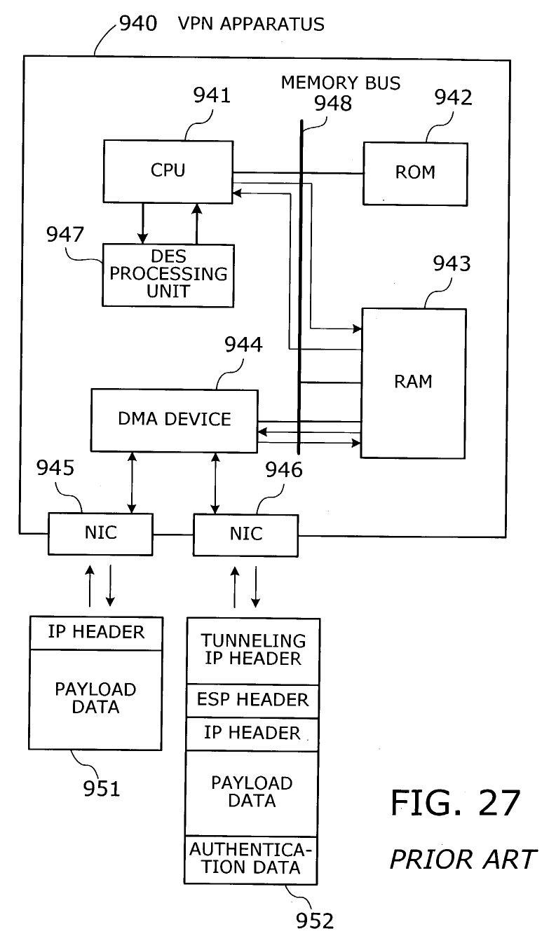

FIG. 25 is a diagram illustrating an example of an ID card used in the ninth embodiment. In the ninth embodiment, in order to prevent unauthorized acquisition of a key code or IV by use of a counterfeit card, multistage authentication is performed. For example, as illustrated in FIG. 25, the ID card 740 comprises a card number 741 and secret-data-protection memory modules 742 and 743, where the secret-data-protection memory module 742 stores an authentication number 742a for identifying a genuine user, and the secret-data-protection memory module 743 stores identification information 743a identifying the genuine user. In addition, the stored authentication number 742a is encrypted by DES, and the stored identification information 743a is encrypted by 3DES.

Since the strength of encryption is changed according to the degree of secrecy of data, it is possible to increase difficulty of unauthorized conduct.

[Other Variations]

The functions of the secret-data-protection memory module indicated in each of the above embodiments can be implemented in a semiconductor chip (semiconductor memory chip).

Although, in the explained case, the DES is used as an encryption/decryption technique, it is possible to use other encryption/decryption techniques.

As explained above, according to the present invention, a duplicate of data which is inputted through an external-bus-connection terminal and stored in the first memory circuit is also stored in the second memory circuit which is internally connected to the first memory circuit, and processing for encryption or decryption is performed on the duplicate of the above data stored in the second memory circuit. Therefore, the external bus is not occupied during the encryption or decryption of data. That is, even during the processing for encryption or decryption, the data stored in the first memory circuit can be accessed from outside. In addition, efficiency of processing using input data can be increased.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A memory device comprising:
a first memory circuit which stores data inputted through an external-bus-connection terminal;
a second memory circuit which is internally connected to the first memory circuit, acquires a duplicate of the data stored in the first memory circuit, and stores the duplicate; and
an encryption/decryption circuit which is internally connected to the second memory circuit, performs processing for encryption or decryption of the duplicate of the data stored in the second memory circuit, in response to an input of designation of an operation, and returns a result of the processing to the second memory circuit.

2. The memory device according to claim 1, wherein when a storage area to be processed, in a memory area of the second memory circuit, is designated, the encryption/decryption circuit performs processing for encryption or decryption of only data stored in the storage area.

3. The memory device according to claim 1, wherein every time a portion of the data is stored in the first memory circuit, the second memory circuit stores a duplicate of the portion of the data.

4. The memory device according to claim 3, wherein the duplicate of the data stored in the second memory circuit are divided into a plurality of portions each having a predetermined unit data length, and
every time one of the plurality of portions of the duplicate of the data is stored in the second memory circuit, the encryption/decryption circuit performs processing for encryption or decryption of the one of the plurality of portions of the duplicate of the data.

5. The memory device according to claim 4, wherein the encryption/decryption circuit is provided corresponding to each of the plurality of portions of the duplicate of the data, and
the encryption/decryption circuit corresponding to each of the plurality of portions of the duplicate of the data comprises,
a processing-timing detection circuit which monitors whether or not processing for encryption or decryption of another of the plurality of portions of the duplicate of the data which precedes said each of the plurality of portions of the duplicate of the data is currently performed, and detects completion of the processing for encryption or decryption of said another of the plurality of portions of the duplicate of the data, and
an encryption/decryption execution circuit which performs the processing for encryption or decryption of said each of the plurality of portions of the duplicate of the data when the processing-timing detection circuit detects completion of the processing for encryption or decryption of said another of the plurality of portions of the duplicate of the data.

6. The memory device according to claim 5, wherein the processing-timing detection circuit corresponding to said each of the plurality of portions of the duplicate of the data outputs a predetermined value when the processing for encryption or decryption of said each of the plurality of portions of the duplicate of the data is completed, and
when the processing-timing detection circuit corresponding to said another of the plurality of portions of the duplicate of the data outputs the predetermined value, the processing-timing detection circuit corresponding to said each of the plurality of portions of the duplicate of the data determines that the processing for encryption or decryption of said another of the plurality of portions of the duplicate of the data is completed.

7. The memory device according to claim 1, wherein the encryption/decryption circuit has functions of processing for encryption or decryption in a plurality of processing modes, and determines one of the plurality of processing modes according to an input from outside.

8. The memory device according to claim 1, further comprising an interrupt notification circuit which outputs an interrupt signal when processing for encryption or decryption of the duplicate of the data is completed.

9. The memory device according to claim 8, wherein the interrupt notification circuit outputs an interrupt signal when a data length of the duplicate of the data stored in the second memory circuit coincides with a data length of portions of the duplicate of the data of which processing for encryption or decryption is completed.

10. The memory device according to claim 8, wherein the interrupt notification circuit outputs an interrupt signal when processing for encryption or decryption of a unit data which is designated in advance as an end unit data is completed.

11. A semiconductor memory chip comprising:
a first memory circuit which stores data inputted from outside;
a second memory circuit which generates a duplicate of the data stored in the first memory circuit, and stores the duplicate; and
an encryption/decryption circuit which performs processing for encryption or decryption of the duplicate of the data stored in the second memory circuit, in response to an input of designation of an operation, and returns a result of the processing to the second memory circuit.

12. A method for performing processing for encryption or decryption of data which is inputted or outputted in and from a memory device, comprising the steps of:
(a) storing data which is inputted into the memory device through an external-bus-connection terminal, in a first memory circuit in the memory device;
(b) performing processing for encryption or decryption of a duplicate of the data stored in the first memory circuit, in response to an input of designation of an operation, by using an encryption/decryption circuit which is internally connected to the first memory circuit in the memory device; and
(c) storing a result of the processing in a second memory circuit which is internally connected to the encryption/decryption circuit.
